(19) United States
(12) Patent Application Publication
(10) Pub. No.: US 2004/0246473 A1
(43) Pub. Date: Dec. 9, 2004

(54) Coded-light dual-view profile scanning apparatus

(76) Inventors: Terrance John Hermary, Coquitlam (CA); Alexander Thomas Hermary, Belcarra (CA)

Correspondence Address: GREENBERG TRAURIG LLP, 2450 COLORADO AVENUE, SUITE 400E, SANTA MONICA, CA, 90404, US

(21) Appl. No.: 10/804,427

(22) Filed: Mar. 18, 2004

Related U.S. Application Data
(60) Provisional application No. 60/455,451, filed on Mar. 18, 2003.

(51) Int. Cl. G01N 21/00

(52) U.S. Cl. 356/237.1

(57) ABSTRACT

A scan head for a surface profile scanner includes two spaced laser projectors and two spaced CCD cameras, aligned with one another, for scanning an object such as a log or board moving along a sawmill production line and for determining the location of points on the surface of the scanned object, thereby generating data from which the surface profile of the object can be computed. For log scanning, the projectors both project coded light patterns. For board scanning, one projector projects a coded light pattern and the other a fan of uncoded light. The lasers and cameras are grouped in two pairs, one pair at each end of the scan head, preferably with the cameras bracketing the lasers, such that four sets of reflection data are available, through time-division multiplexing, in order to enable recognition of the image of the pattern reflected from the object and to optimize data readings from triangulation (to calculate the distances from the scan head to a series of points on the object). In the case of board scanning, the uncoded light image may be used for gray-scale image generation, board edge detection, and reflectivity compensation.

### RELATED APPLICATION

This application claims priority to U.S. Provisional Application Ser. No. 60/455,451, filed Mar. 18, 2003 entitled “Electromagnetic Scanning Apparatus”, the contents of which are incorporated by reference herein in their entirety.

### BACKGROUND

1. Field of the Invention

The set of inventions herein described relates generally to scanning apparatus suitable for obtaining data for determining the surface profile of a scanned object. In some aspects, this invention constitutes a set of improvements of the scanning apparatus described in U.S. Pat. No. 5,615,003 issued 25 Mar. 1997 (“Hermary '003”) and U.S. Pat. No. 5,986,745 issued 16 Nov. 1999 (“Hermary '745”)), both of which are incorporated herein by reference. However, the scanning apparatus and methodology of the present set of inventions transcend those described in the prior Hermary patents.

2. Background of the Invention

The location and topography of the surface of a scanned three-dimensional object are determined by scanning of the object and then determining the location of a representative set of points on the surface of the object, which points are sufficiently proximate to one another that the shape and position in space of the object can be determined to a desired degree of accuracy. Typically, the result sought is expressed as a collection of points relative to a selected set of coordinates (x, y, z). For example, the Y-axis may be selected to intersect all sources (that may be virtual sources, depending upon the optics used) of projected electromagnetic radiation and all receptors for receiving electromagnetic radiation comprised within any given scan head of the scanner; in a given scan head, the Z-axis may be midway between the projector and receptor and parallel to the path of travel of the scanned object past the scanner, or vice versa. Since relative motion can be accomplished by moving either the scanner or the object being scanned, a further option would involve keeping the scanned object stationary or moving slowly, and moving the projection beam relative to the scanned object so as to cover the desired angle of scan. Either way, the projected beam and scanned object undergo relative motion, and the position of the image of a portion of the scanned object moves relative to the receptor. The X-axis may be othogonal to each of the y- and z-axes at the point of intersection of the Y— and Z-axes. In this selection of coordinates, the value of x of any point on the surface of the scanned object represents the distance x to that point on the surface from a point (y,z) in the selected Y-Z plane orthogonal to the X-axis. Of course, the selection of X, Y and Z axes is completely arbitrary; the foregoing is merely representative of a convenient selection.

Previously known scanning techniques include the following:

(a) Keeping the scanned object stationary, a projector and a camera can be moved stepwise within the Y-Z plane and a set of distance values x measured one at a time. Alternatively, the projector and camera can be kept stationary and the object can be moved stepwise so that a series of spaced line scans are obtained. Very exact measurements, as may be required in such applications as medical or dental imaging, can be obtained by this technique, but it is slow and cumbersome.

(b) A pattern of spots, typically arranged in a grid, are projected simultaneously over the surface (the “grid technique”). The received image is analyzed to determine the angles of reception of the grid points. As the angles of projection are already known, triangulation allows the calculation of the location of all the grid points relative to the base line. However, this technique requires the matching of an apparent point in the received image with a corresponding point in the projected pattern. If the surface has occlusions or sharp, prominent features, the received signal may be missing data corresponding to one or more portions of the surface profile, causing a mismatch between the received image and the projected pattern. Where the matching technique relies on counting the coordinate of a grid point (“third point across, sixth point up”) the effect of missing the data for even one point can be significant.

The foregoing technique, like many other scanning techniques, makes use of the well known principle of triangulation. This trigonometric principle is based on the understanding that if at least one side of a triangle is known, all of the sides and angles of the triangle can be determined if any two of the values for the three angles and the other two sides are ascertained.

(c) A number of variants to the grid technique are possible. A beam may be made up of a line of points and this can be swept across the surface of the object (“beam sweeping”). Alternatively, a sequence of beams can be projected over the surface, one at a time (“time multiplexing”). These modified techniques require longer observation times than the basic grid technique but are less prone to serious errors from a missing or mismatched point. For example, if the third point in a line of points is missing from the reflection data due to occulusion or poor reflectivity of the projected beam, then points occurring after the third in the line of points will be miscounted by one. However, as the beam moves on, the missing third point could well reappear in a fresh reflected signal, and the counting could proceed correctly, if all the reflection data are processed to best advantage.

In some cases, the ambiguity or uncertainty can be reduced by the use of a reference spot whose coordinates are known, thereby enabling the operator to establish a correspondence between at least one point on the scanned surface that has been illuminated by the transmitted beam, and one detected spot. However, ambiguity or uncertainty would remain a problem, even if the reference spot can be located unambiguously, as the identification of spots other than the reference spot depends on the assumption that no spots between the reference spot and the spots to be identified are obscured or otherwise not detected.

(d) In some applications, such as semiconductor manufacture, the scanning apparatus needs to be able to resolve features on the surface that are of the order of micrometres or smaller in size. For these applications, interferometric techniques can be used. However, these techniques can measure only small variations in surface height, and require that the scanned object be stationary.

(e) In some techniques, beams of different colors are used to improve the ability to match points in the received image with the projected beams. However, such techniques each require a multitude of projectors to provide light at different frequencies. This complicates the apparatus and makes it more expensive to manufacture.

(f) “Sheet-of-light” scanners project one or more planes of light onto a surface. Each sheet of light intersects the surface in a line. A camera offset from the plane has a two-dimensional array of photosensitive elements, on which are recorded the images of the lines projected onto the surface. Triangulation makes it possible to measure the profile of the surface from a series of detected line-images as the object moves past the scanner. However, where more than one line at a time is projected, sheet-of-light scanners may have difficulty distinguishing between the different lines recorded in the received image.

A drawback of sheet-of-light scanners is that they require an unobstructed view of the object by a camera placed in a position offset from the plane of the projector. In some industrial applications, it is difficult or impossible to arrange an unobstructed view of the entirety of the surface to be scanned. For example, very commonly, logs in a sawmill production line are transported past the scanner on a set of conveyor flights that support the logs. These flights are fixed with respect to the log and move along guide rails. For a scan of the uppermost surface, the flights do not interfere with the imaging. However, for the lower surface of the log, the flights necessarily intercept the beams, causing considerable image occlusion.

In many scanning situations, the scanned object is moving fairly rapidly. For example, in a sawmill, logs have to be sized as they move along a conveyor at fairly rapid speeds; speeds of 2.5 m/sec (8 feet per second) are commonplace. To obtain a series of profiles that are 1 cm (0.4″) apart along the axis of the log requires that a scanning cycle be completed in less than 4 milliseconds. A scanning cycle involves a linear scan of points on the object to be scanned along a line generally parallel to the Y-axis, say, slightly but immaterially skewed by reason of the slight movement of the log parallel to the Z-axis, say, during the scanning cycle. The foregoing scanning speed requirement renders unusable or unreliable some of the prior scanning techniques mentioned above.

Further, the environment may be unfavorable to the scanning process. A typical sawmill environment is dusty, wet, noisy and subject to considerable vibration. Suitable scanning equipment needs to be rugged, simple in construction and easy to operate. This means that the scanner should preferably be made up of as few parts as possible, none of which should be moving parts. Further, there are sometimes bright lights or high-reflectivity objects present within the field of view of the receptor that constitute optical interference (visual “noise”) to the receptor. Some prior apparatus and techniques are relatively ineffective in discriminating the image signal from the optical interference.

In short, many of the prior scanning techniques do not work reliably in a rough industrial environment in which the object to be scanned is of unpredictable profile, is supported on a conveyor of some sort, and moves at relatively high speed along a production line in an environment that can be expected to be hostile to some extent.

A commercially and technically successful scanning apparatus suitable for scanning logs as they pass along a sawmill production line is described in Hermary '003 and Hermary '745. Apparatus of the type described in these Hermary patents uses a non-contact scanning method to determine within an acceptable degree of approximation the location and topographical configuration of the surface of a scanned object such as a moving log. In the prior Hermary technique, a coded electromagnetic beam, preferably a laser-produced beam of light, is projected onto the object to be scanned. The projected beam is fan-shaped, being shaped approximately as a sector of a disc lying in the X—Y plane (using the coordinate system suggested above) with a broad planar area and a narrow thickness. The scanner in one scanning cycle measures points along the intersection of the beam's plane with the moving surface of the object; the scanning cycle is repeated periodically as the log moves past the scanner. In each subsequent cycle, the line of intersection of the beam with the object will have shifted by the amount of the log's travel in the time between the successive scans.

The prior Hermary receptor comprises a detector, conveniently including a CCD-array; the detector is sometimes referred to herein as a “camera”. The light beam projector and reflected image detector are both mounted in a scan head; the projector and detector are spaced from one another along a line perpendicular to the direction of motion of the log, which line conventionally defines the y-axis. In some applications, such as scanning a single sawn face of a log, sufficient surface measurement data can be gathered from a single scan head. In other applications, such as a scan to determine the complete three-dimensional shape of a log, it may be necessary to employ two or more scan heads spaced around the periphery of the object. Or it may be desirable to devise an array of aligned scan heads arranged end to end. For example, the Hermary '745 patent describes a coplanar configuration with four scan heads that surround the path of travel of a log along a sawmill production line.

Hermary apparatus of the foregoing type uses light, or other radiation, patterned with a coded structure. The coding is chosen so that sub-sequences of the received signal, longer than a predetermined length, can be uniquely associated with a corresponding identifiable portion of the projected beam. The coding enables the apparatus to determine the surface location and configuration even if, as is usual, some reflected radiation data are missing or unreliable.

The calculation of the location of points on the scanned object's surface is done by triangulation. To this end, the projector and camera in each scan head, and a scanned point on the surface of the object, are at the vertices of a triangle. In many designs of such apparatus, it will be convenient for space-saving purposes to reflect the beam produced by the projector, and sometimes the reflected image rays, using one or more mirrors, before the beam leaves the scan head; the beam becomes “folded” as a consequence. Such folding of the optical path is commonplace in optical instruments. Note that the triangle used for triangulation computations includes as one apex the virtual source of the projected beam, not the actual source. One side of the triangle, viz the distance between the virtual projector source and the virtual camera focal point location (the “base line”), is known. The angles with the base line made by the projected and received beams associated with the scanned point, whose position on the scanned object is determined using the projected coded pattern and received reflected signal from the scanned object, are measured. Standard trigonometry is then used to calculate the x-coordinate of the point, viz the position of the point on the scanned object relative to the base line.

In a preferred embodiment of the previous Hermary technology, the coding of the projected pattern of light or other suitable radiation is selected to conform to a sequence of boolean values chosen so that any sub-sequence of length N bits is unique within the complete sequence. (N is a parameter suitably chosen by the designer and may desirably be empirically selected to achieve an acceptably low proportion of rejected or unreliable image reflection data.) Such coding conforms to de Bruijn cycles or patterns, acknowledging the work of N. G. de Bruijn who analyzed such coded patterns in 1946. Such patterns are conveniently described in “The Art of Computer Programming” (D. E. Knuth, v1, 2nd edition, Addison Wesley, 1973). With this coding, it is possible to analyze the received light and locate the position of a received pattern of N bits uniquely within the original projected beam.

For example, if the elements of the pattern are binary and N is chosen to be 6, the de Bruijn cycle or pattern would conventionally expressed to be a (2,6) de Bruijn cycle or pattern. Such pattern that contains each pattern element exactly once is of length 69 (2N+N−1). One example of such a cycle is the following sequence:

000000111111011110011101011100011011010011001011000010101000100100000

In the prior Hermary technique, the beam carries the de Bruijn coding as a pattern containing identifiable elements conforming to a boolean sequence of ones and zeros (1's and 0's). In practice, the ones and zeros represent different states of a characteristic of the projected light pattern that should be recognized and identified to an acceptable level of reliability in the received signal. In a preferred embodiment described in the Hermary patents, each element (“symbol”) of the pattern comprises a bright band or “mark” followed by dark band or “space” between successive marks. In that preferred embodiment, the length of a symbol is three units of selected length, the length of a mark may be either one or two units of the same selected length, and similarly the length of a space may be either one or two units of the same length. The symbol length is chosen to be small enough that measurements and computed x, y, z values of the desired resolution can be made. In the foregoing embodiment, a boolean 0 is represented by a one-unit mark followed by a space of two units; a boolean 1 by a two-unit mark followed by a one-unit space. In both cases, the beginning of the symbol is a transition from low intensity light to high intensity light. The length of the mark is the distance from its beginning to the next transition from high intensity to low intensity. Similarly, the length of the space is the distance from the end of the mark to the beginning of the next symbol.

The transitions described above are detectable changes from one state or attribute to another. Generally speaking, de Bruijn coding and discrimination can also work effectively where each projected element has a selected one of more than two possible states (for example: red, green and blue light) or has a selected one of a variety of different possible attributes (such as the intensity, wavelength or polarity of light).

The previous Hermary coded light patterns are preferably detected by identifying abrupt changes in brightness or darkness and specifically by detecting the edges of marks and spaces. This enables the system designer to design detection and analysis apparatus and methodology in terms of rising and falling levels of reflected light intensity.

The data produced by a previously known Hermary surface profile scanner can be further analyzed and processed according to a variety of known techniques to obtain useful technical or industrial results. For example, in a sawmill, the resulting set of (x,y,z) coordinates of points on the surface of a scanned log, the collectivity of which represents that portion of the surface of a scanned log that is scanned, can be used, for example:

(i) in combination with similar data obtained from other scan heads providing image data for other scanned portions of the surface of the log, to obtain data representative of the complete surface profile of the log, or an acceptable approximation of same;

(ii) to drive a monitor to display a graphic representation of the scanned portion of the log;

(iii) relative to a saw on the production line downstream of the scanner, to direct the orientation of the scanned log and the choice of dimensions of lumber to be cut from the log so as to maximize or at least enhance the value of the sawn lumber produced; and

(iv) to determine the location of knots and gouges that could potentially reduce the value of sawn lumber, and cut the lumber accordingly.

The apparatus described in the foregoing Hermary patents provides in most instances reliable surface scans of logs or other similar objects moving in an industrial processing line. The prior Hermary scanning apparatus enables the determination with good reliability of the surface profile of logs to be sawn in a sawmill for the purpose of adjusting sawing equipment to optimize the quantity or value of the lumber produced. The prior Hermary apparatus has the following characteristics:

(a) It can make relatively rapid measurements of the profile of an object. As the object moves past the measuring apparatus, the surface contour of the entire object can be constructed from a series of surface profiles each captured at a given longitudinal distance along the object.

(b) It is relatively insensitive to missing or poor-quality portions of the received image data. Cavities and occlusions on the log surface and similar problems may typically give rise to the loss of the occasional single datum point or perhaps even a short series of such points, but the image taken as a whole is not lost, assuming a suitable selection of projected electromagnetic radiation and coding, a suitable arrangement of projector and camera within the scan heads, suitable positioning of scan heads about the log to be scanned, suitable resolution of the camera, and suitable data processing techniques applied to the camera output signal, as described in the prior Hermary patents.

(c) It is compact, rugged, with a minimum of moving parts.

(d) It does not require frequent calibration.

(e) Again assuming a suitable choice of equipment and operating parameters, it has sufficient resolution and depth of field to measure accurately irregular objects such as logs.

The Hermary patents disclose a sophisticated data processing capability that assesses the reliability of the scanned object surface profile data, is able to reject at least some erroneous data, is able to establish correlations between the projected pattern and the received pattern reflection data even when some of the received data are missing or unreliable, and is able to extrapolate between known points to approximate the profile if some profile data are missing. This capability requires not merely processing complexity but adequate data processing speed. The time required to process data can be a limiting factor in determining the maximum resolution available of the scanned object profile measurement. Consequently any improvement that could be made to similar such apparatus that would reduce the data processing time per scanning cycle could enable more scans per second to be effectively made.

As mentioned, unambiguous recognition of the reflected pattern of light and the consequent processing of data dependent upon pattern recognition by the previously known Hermary apparatus is rendered more difficult by the occasional occlusion of the light beam arising from, for example, irregularities on the surface of a scanned log (for example, bumps or branch stems). Such irregularities occasionally produce a failed match or mismatch between the signal received from a portion of the surface of the scanned object and the pattern projected in the transmitted scanning beam. Alternatively, an obstruction may block the camera from receiving the light reflected back from a portion of the log's surface. Cavities and cracks in the log can capture portions of the projected beam, providing ambiguous or no detectable reflection. Further, as a log is carried by a conveyor, the beam may fall on a portion of the conveyor mechanism instead of the log. Consequently, portions of the reflected light signal may be unreliable and consequently may have to be rejected. While the prior Hermary apparatus described above provides a relatively high degree of accuracy and reliability in surface profiling, some of the problems noted above may defy the prior Hermary apparatus on occasion.

Some prior designers have proposed binocular scanning, i.e. scanning of the target object using two spaced cameras. For example, Leong in U.S. Pat. No. 4,937,445 granted June 1990 discloses a two-camera variant of scanning apparatus, and McBain in U.S. Pat. No. 6,466,305 B1 granted 15 Oct. 2002 discloses what is said to be an improvement of the Leong apparatus. McBain discloses an array of collimated lasers each of which projects orthogonally a spot on the target object. The array of projected spots on the object is viewed by two different viewing cameras whose outputs can be compared in order to resolve ambiguities in the data. The need for a bank of several lasers makes McBain's proposal relatively expensive, and his failure to appreciate the desirability of projecting coded light renders his proposal less than state-of-the-art. However, the binocular facility, also proposed by others, can be a useful modification of Leong.

Other designers have devised binocular scanners that are subject to other design deficiencies. McBain reviews a number of these in his patent.

### SUMMARY OF THE INVENTION

A principal objective in the design of moving-object profile scanners such as those described in the mentioned Hermary patents is to reduce the incidence of null, erroneous or ambiguous output data. Desirably, the spatial coordinates of as many points as possible on the surface of the scanned object are identified. Desirably, initially unreliable camera output data can be rendered reliable by suitable data processing techniques; to that end, the scanning process and apparatus should facilitate optimally effective data processing techniques. The Hermary patents disclose apparatus and methodology that accomplish these objectives successfully in many industrial situations requiring moving-object scanning, of which log scanning in sawmills is an exemplary industrial application of the techniques described in those patents.

A key feature of the prior Hermary scanning technique is the projection onto the scanned object and reflection from the scanned object of coded light; coded electromagnetic radiation of other frequencies could be used in other contexts. It should be understood that references to light in this specification are exemplary and that electromagnetic radiation of other frequencies could be substituted for use in other scanning applications. The use of coded light enables determination of multiple spatial coordinates of the profile of the scanned object with a relatively high degree of reliability—the coordinates of enough points on the profile are ascertained that in most cases for which apparatus according to the present invention is suitable, the entire scanned object profile can be determined to the requisite resolution. In a preferred scan head embodiment of the present invention, scanning apparatus is provided that continues to use coded light or other suitable coded electromagnetic radiation, but expands that use to generate and process reflection data received from two detectors in the scan head that are spaced from one another along or parallel to the Y-axis (using the conventional system of coordinates identified elsewhere in this specification).

In a preferred embodiment of a scan head according to the invention, two projectors, preferably laser projectors, are mounted in a housing along with two cameras that preferably comprise CCD or CMOS detectors and are generally coplanar with the projectors within the housing. The housing is opaque except for the windows for the detectors and projectors. The separation between the cameras and between the projectors, and the degree of proximity of each camera to its neighboring projector, are selected so that the triangulation computation can generate scanned object surface profile data to the requisite resolution, so that there is ample room within the scan head housing for all of the necessary equipment, and so that the projected beams illuminate the surface of the object from significantly different angles.

If only one projector is used, one detector is preferably located proximate to the projector within the scan head and the other is located remote from the projector, for reasons to be elaborated below. If two projectors are used in the preferred dual-beam dual-view scan head arrangement according to the invention, the two projectors are located within the scan head and aligned with the detectors along or parallel to the Z-axis, each projector being proximate to a neighboring one of the two detectors. The focal points of both projectors and both detectors lie in the same X—Y plane. Preferably the two detectors bracket the two projectors, meaning that (in the case of folded optical paths) the virtual focal points of the cameras lie generally outside the virtual focal points of the projectors, such that relative to that array, each detector lies outside its neighboring projector, just as punctuation brackets surround a parenthetical phrase in a sentence, or just as in a mathematical equation, brackets surround a plurality of individual variables or expressions. As before, the detectors preferably comprise linear CCD or CMOS arrays and the projectors are preferably laser projectors.

While arrangements other than the foregoing are possible that provide some of the advantages of the invention, the foregoing arrangement is preferred for many industrial applications such as log scanning in a sawmill, so that in operation, for each projection of light (or other suitable radiation) from a projector, separate reflection data are obtained from the two cameras (detectors), one set of reflection data representing a near-view scene and the other a far-view scene. The term “near view” implies that the camera referred to is close to the neighboring projector whose projected light is reflected from the scanned object; the term “far view” implies that the camera referred to is remote from the projector whose projected light is reflected from the scanned object. Note that if the cameras bracket the projectors, it is relatively unlikely that both cameras will concurrently fail to detect the image of the projected light. Further, spacing the cameras as far apart as possible (for any given scan zone) increases the baseline for triangulation computation purposes, thereby obtaining relatively high resolution of the spatial coordinates of any given point on the surface of the scanned object.

There is some risk that a projected beam may from time to time be “captured” by a crack or severe surface depression on the scanned object, or be blocked by an occluding object, or otherwise be interrupted and not reflected back to one of the two cameras. The fact that two cameras receive the projected beam renders it unlikely that both cameras would be unable to generate useful reflected signal data—the combined received data afford a relatively high probability that useful reflected pattern data can be recovered and processed to advantage. Further, if two projectors are used in the scan head, the fact that the projectors are spaced appreciably from one another and that the cameras are spaced appreciably from one another renders it unlikely that both projected beams and both received reflected signals will no,t be efficacious—with two projectors and two cameras, there are four possible combinations of projected pattern/reflected pattern data, and the chances are high that at least one combination of projected and received pattern data will prove to be reliable and useful for any portion of the scanned object surface within a reasonably selected projection and viewing angle.

Where two projectors are used within the scan head, both projectors may project the same pattern, preferably a suitably coded light pattern, or may project two different patterns. The choice may depend upon the industrial application in question. For board scanning, it is convenient for one projector to project a suitably coded light pattern, and the other to project a “fan of light”, i.e. a relatively narrow line of uncoded light in the X, Y plane and having a narrow extension in the Z-dimension. Detection of the reflection from the scanned object at the intersection of the fan of light with the object's surface may serve several purposes, including gray-scale imaging, and target edge detection of the boundary edges of the scanned object (or other abrupt interruption of the surface of the scanned object), although the distance data using the coded light reflection data give accurate target edge information. The fan-of-light image data may also be used to generate target object surface reflectivity data for use in compensation or balancing of coded image reflection data, as will be described in more detail below. In order to avoid ambiguity in the reflected image signal data, preferably the projectors operate alternately in timed sequence so that one projector is OFF when the other is ON—neither projects a beam of light while the other is projecting light onto the scanned object. Note that when distance data are obtained relative to a given camera, those data may be correlated precisely with the gray-scale image data, since the pixel in the camera is the same for both images for any known point on the target surface.

In some situations, the apparatus designer may prefer that one projector project a coded pattern formed on a coarse scale (larger pitch) and the other a coded pattern formed on a fine scale (smaller pitch), which arrangement may be desirable where the scanned object has a rough, uneven surface with abrupt surface irregularities. For example, it may be necessary to scan a log having a large amount of surface bark yet which also has a large debarked surface area. In such case, the large-pitch scan may yield useful profile data to an approximate degree of resolution for the bark surface, while the small-pitch scan might yield little usable profile data for the bark surface, but would provide relatively high-resolution profile data for the debarked surface. Combining the two sets of data would then generate combined log profile data that would in many cases be the best data available, whereas confining projection to a smaller-pitch pattern throughout might not generate useful data for the bark surface.

As in the case of the prior Hermary patents, the projected coded pattern or patterns may be comprised of symbols characterized by two or more distinguishable characteristics of the projected radiation such as alternating bright and dark portions of the pattern. Such patterns may be de Bruijn mark/space patterns of the sort described elsewhere in this specification. Or such patterns may be generated as other coded combinations of discernibly different characteristics of the projected radiation, such as color or polarity. In at least some cases, it may be found acceptable to use less elaborate patterns such as modified subsets of de Bruijn patterns.

Where the patterns comprise sequential alternating bright and dark signal components, then the symbols of which the projected pattern is comprised are preferably detected and recognized by means of signal edge detection techniques. In this methodology, one may usefully think of symbols as comprising a series of edges separated by alternating bright and dark pattern portions of differing lengths from symbol to symbol. A conventional boolean symbol in such patterns can be considered as a rising edge (an abrupt upward slope of the light intensity as the dark portion (space) ends and the bright portion (mark) begins), followed by a falling edge as the dark portion (space) begins, and terminating when the next rising edge occurs. In the typical de Bruijn patterns described in the prior Hermary patents, the symbols were either a mark of 2 units of length followed by a space of 1 unit of length, or else a mark of 1 unit of length followed by a space of 2 units of length, thereby generating the 1's and 0's of the pattern code.

Another way of thinking of the foregoing symbols is to say that they are of equal length, and that in one of those two selected symbols, the duty cycle for the bright (mark) portion is 33% and the duty cycle for the dark portion (space) is 67%; whereas in the other of those two selected symbols, the duty cycle for the bright (mark) portion is 67% and the duty cycle for the dark portion (space) is 33%. In accordance with one aspect of the present invention, a third symbol is used that has a duty cycle for the bright (mark) portion of 50%, and has a duty cycle for the dark portion (space) also of 50%. In that case, it has been found desirable to adjust the duty cycle slightly for the other two symbols to facilitate distinguishing them from the 50% symbol, so that in a preferred embodiment, the three different marks have respectively duty cycles of 30%, 50% and 70%. Using three discernible types of symbol makes it possible to use fewer symbols in unique sub-sequences to satisfy the de Bruijn objective of providing a pattern in which any sub-sequence of a given length is unique within the complete sequence.

It is apparent from the foregoing discussion that further symbols beyond the three mentioned could be used, but with increasing difficulty of distinguishing the reflected symbols from one another if the recognition characteristic is the duty cycle of a mark in a mark/space symbol. Detection and recognition of symbols in this context involves detection of rising and falling signal edges and of duty cycles. Assuming a pattern formed of a continuous contiguous set of symbols of the foregoing sort, note that with two exceptions, the terminating edge of one symbol is the leading edge of the next following symbol. The two exceptions are the very first symbol in the sequence and the very last symbol in the sequence. Suitable data processing is required in order to distinguish the first and last symbols from the intervening others.

If a scan head according to the invention includes two projectors and two cameras, the projectors should preferably operate in time-multiplexed mode so that the patterns projected from the two projectors alternate in time sequence. The cameras operate in synchronism with the projectors, and both cameras preferably provide output data for each projection. In this embodiment of the invention, a scanning cycle includes a projection from each projector, so the output data comprise four scenes, two from each camera, each camera detecting an image for each of the two projections (one image for each camera from each projector). Having four images from four different viewing scenes so as to generate four different sets of data significantly increases the pool of data available from which to extract reliable matches of reflection data to projected pattern symbols or elements, as will be discussed in further detail below.

Where a complete scanning apparatus includes two or more scan heads, it is advantageous to operate the scan heads in suitable time sequences so that interference between neighboring scan heads is minimized.

Note that if a pattern that begins its existence as a regular pattern of uniformly spaced elements such as symbols of any of the types described above will usually suffer at least some distortion as it passes through the series of steps involved in a scanning operation. It may suffer distortion in the beam of projection, the distortion becoming increasingly severe as the point on the scanned object becomes more remote from, and at a greater angle to, the projector that projected the pattern. It may suffer distortion through the process of reflection, partly because of irregularities in or changes in orientation of the surface of the scanned object from one end of the scan to another, and partly because of the changes in the angle of view of the viewing camera as one proceeds from one end of the pattern to the other over the field of view of the camera. Accordingly, scanning of the object requires that symbols or other pattern elements be detected in their distorted form. This implies that the matching steps in the reflection data processing must take into account the probable existence of pattern distortion.

To facilitate matching, it is useful to attempt to identify periodicity in the detected signal, the expected periodicity to be within some set percentage (say) of the periodicity of the projected signal, with due allowance for the effects imposed by the geometry of the scanning layout. What appear in the detected signal to be a series of signal edges that would accord in periodicity with symbol edges (albeit the edges of distorted symbols) can be accepted as identifying valid reflected symbol images, and other portions of the received signal can be rejected. Knowing that the camera operating in near-view imaging relative to the neighboring projector is likely to receive reliably reflected identifiable symbols from the near end of the projection on the scanned object, where the camera viewing angle is very close to the angle of projection, matching should be relatively easy and reliable at the corresponding end of the received signal, and the rest of the data will tend to fall into place once the matching of firmly reliable pattern symbol data has been effected at that close viewing angle. It is helpful in the matching process to analyze the data for ostensibly matching symbol edges or duty-cycle values.

Where the scan head includes two projectors, the projectors are preferably separated by a distance sufficient that the projected beams illuminate the surface of the scanned object from significantly different angles. In near-view imaging, the angle between a given projected ray and the corresponding reflected ray should be kept very small, as the chief objective of near-view imaging is reliable symbol recognition rather than high resolution of distance data. In far-view imaging, distance resolution is the primary objective, so the baseline for triangulation should be relatively long. Preferably the projection rays and reflection rays are at moderate acute angles to the Y-axis, for example, roughly in the range 45° to 135°. Note that for effective triangulation, no angle of the triangle at either end of the baseline should approach 180°. In near-view imaging, the reflected image obtained from the neighboring camera typically suffers very little distortion, and consequently the reflected pattern data are very reliable for the purpose of symbol recognition (because the angle between the incident beam and reflected beam is small). However, because the known side of the triangle for triangulation computation is also small, the distance calculation for the scanned surface point in question would be expected to be of relatively low resolution. Accordingly, higher resolution of the coordinates and particularly the -coordinate of the scanned object surface points is usually obtained using far-view imaging. In some cases, as detailed further below, the triangulation computation baseline selected may be a camera-to-camera baseline for maximum precision in calculation of the x-coordinate of the scanned object surface points.

The foregoing distinction between the purposes and results of near-view imaging and those of far-view imaging also apply to scan heads according to the invention that use only one projector. But an advantage in using two projectors as described above is that high-resolution pattern recovery data are available from near-view operation at both ends of the scanning range along the Y-axis. Note that if a projector in a two-projector arrangement fails, the scan head can default to single-projector operation, which, while not affording the foregoing advantage, may nevertheless serve to generate reliable distance data so as to enable the profile of the scanned object to be ascertained.

Because, as will be developed in more detail below, the present invention places boundary limits on the range of valid reflection data, the de Bruijn or other suitable coding used in association with the present invention can typically be selected to be of a lower level than required for the prior Hermary technology. Whereas (2,6) de Bruijn coding might have been suitable for typical prior Hermary scanners, de Bruijn coding as low as (2,3) or (2,4) (if only two distinguishable elements of a symbol are used) may be sufficient for successful operation of Hermary scanners constructed and operated in accordance with the principles of the present invention, particularly if two projectors and two cameras are used instead of just one projector and two cameras. Nevertheless, since not all problematic operating circumstances or conditions can be reliably predicted, the system designer may prefer that the projected light beam coding be maintained at a de Bruijn level (or equivalent) high enough that it would work satisfactorily in prior Hermary apparatus. That relatively high code level would enable the apparatus according to the present invention to default to operation as if prior Hermary apparatus were being used if, for example, there were a partial equipment component failure. Nevertheless, the higher the level de Bruijn code, the more data processing time is typically required per scanning cycle, so using a lower level de Bruijn code may advantageously permit faster system operation.

The additional data (relative to the data typically available from prior Hermary scanners) obtained from scanning apparatus according to the present invention can be quickly analyzed, to some extent on an a priori basis, to establish (at least approximately) valid data ranges within which received data can be considered definitely or probably reliable and outside of which received data can be considered definitely or probably unreliable. The selection of the valid range will typically depend upon the scanning layout, and particularly upon the zone of intersection of the range of projection angles (beam sector) and the camera viewing angle range (view sector). This constraint on data processing permits the data processor to restrict its processing to data within the boundaries of the valid data range, thus enabling some of the received data to be filtered out and rejected, thereby affording an appreciable saving in the time required to process the data further for symbol or signal edge detection or matching, profile calculation, or for other purposes. One of the potential benefits of the foregoing inventive data processing technique is, as mentioned, the possible acceptance in a given received signal of a partial signal found to be reliable at a lower-level de Bruijn code or equivalent, which in itself can potentially simplify and shorten the time required for valid data recovery and computation.

When the profile of the scanned object is to be determined about the entire periphery of the object, it will ordinarily be necessary to position two or more scan heads about the object so that each scan head may illuminate a portion of the profile of the object, and the collectivity of scan heads may illuminate the entirety of the profile as the scanned object passes by. As developed in the prior '745 Hermary patent, four coplanar scan heads placed around the periphery of the scanned object in a plane perpendicular to the path of travel of the object are sufficient to enable the data processor to calculate, to a reasonable degree of resolution, the entire surface topography and location of the object, with each scan head covering about 90° of the entire 360° periphery of the object. However, if the dual-beam dual-camera scan head of the present invention is used, since near-view and far-view data are reliable at both limits of the view sectors of the cameras, it should be possible to use fewer than the four coplanar scan heads recommended in the '745 Hermary patent—three coplanar scan heads should be satisfactory for log scanning, and as few as two coplanar scan heads may suffice for many applications, including log scanning operations, depending upon system requirements.

In some contexts, for example board scanning, it may be useful to align a series of scan heads end-to-end, so that each head views with relatively high resolution a discrete fraction of one surface of a moving object (subject to the possibility of overlap); this is useful where the remote surface of the object is not of interest or else is scanned by a similar bank of scanners located on the remote side of the object. For example, a cant may be cut cleanly along the remote surface, but the nearby surface may be subject to wane or other imperfections. In such case, a relatively high-resolution scan of the near surface may be useful, and to that end, a series of scan heads aligned end-to-end may be an optimal design choice. Note that better results are usually obtained by limiting both distance-to-target and the projecting or viewing angle of a given projector or camera; this implies that a series of, say, four scan heads aligned end-to-end will usually give more reliable and more easily processed results than would a single scan head four times as long.

Note that when the camera proximate to a neighboring projector does reliably receive a set of pattern elements reflected from that projector, but is able to support only a low-resolution distance computation, the resulting distance computation, even if of relatively low resolution, may be sufficient to establish boundaries or limits on the range of reliable distance values for the scanned object surface points that are correlated with the set of reflected pattern elements. Suppose, for example, that reflection data obtained in far-view imaging are consistent with the position of the small end of a log in any one of four possible locations. If reflection data obtained in the near view are consistent with the position of the small end of the log in only one of those four possible locations, then the other three possibilities can be summarily rejected. And the far-view distance data for that location will be preferred because of the higher distance resolution usually available in far-view imaging.

The data processor processing data from the remote camera operating in far-view imaging mode may encounter more difficulty than in processing data from the proximate camera in recognizing a pattern symbol or element or sequence of pattern symbols or elements for the same set of points, since distortion or occlusion or inadequate reflection of the projected pattern can readily occur when the incident beam is at a relatively large angle to the reflected beam. Surface roughness also a factor in efficacy of symbol recognition. But once pattern elements are reliably identified within the remote camera data (possibly in part by way of comparison with near-view data), the longer triangulation baseline between the projector and the remote camera enables the distance measurement to the corresponding point on the surface of the scanned object to be computed by triangulation to a relatively high degree of accuracy. If the data processor is constrained to accept from the remote camera only data within the distance range boundaries or limits established by the proximate camera, then the data processing task for the triangulation computation becomes simpler and consequently can be performed more quickly—a beneficial result, as discussed above.

In, for example, a log scanning context, as compared with the prior Hermary scanner, branch stems, cracks, “cat-faces” or gouges on the surface of a scanned log are likely to interfere less with the efficacy of the preferred embodiment of the projector/camera arrangement of the present invention, so that reliable data in the detected signal are more likely to be reliably and easily obtained. It is inherent in the dual-beam dual-view scanner invention that since there are four possible combinations of projected pattern/reflected pattern data available for use, some of which combinations offer high reliability of pattern recognition and other of which offer high distance (x-coordinate) resolution, some of the reliable pattern-recognition data may be useful to place boundaries or limits on other higher-resolution distance data that are obtained for the same part of the scanned object's surface from one or more other of the projected pattern/reflected pattern data combinations, with the result that the overall computation of distance data for the scanned object surface profile is both more reliable and speedier than that using the prior Hermary apparatus with one projector and one camera per scan head.

Note that special projectors and cameras are not required for the practice of the invention. For convenience and economy, the projectors are preferably lasers and the cameras preferably CCD or CMOS detectors of the sort generally commercially available. While laser light is easy to work with and is preferred, in principle the invention can be implemented using other forms of electromagnetic radiation.

In the time-division multiplexing functioning of a preferred embodiment of the invention, the scan head alternates between two modes of operation in alternating scanning cycles. During the first half of one complete cycle, light is projected from only the first projector; on the next half-cycle, light is projected from only the second projector, and this alternating cyclical operation is repeated seriatim. Preferably, for each of the two half-cycles, light is detected and analyzed by both cameras. Note that between successive scans, in the intervening period, the scanned object, say a log, has moved downstream through a small distance, so that successive scans of the surface of the log are taken along scan lines whose Z-coordinates (along the Z-axis parallel to the direction of travel of the log) differ slightly by the same small distance, assuming constant speed of travel of the log down the production line. If, for example, a portion of the scanned surface is obscured in the view of one camera by a branch stem on the first-projector cycle, that same portion of the surface may well be visible to the second camera when illuminated with the second projector on the next cycle, since the angles of the incident and reflected beam for the second cycle will be substantially different from those of the first cycle. This time-division multiplexing aspect of the invention tends to give the scanner (with the associated signal processing circuitry) useful reliable data; the loss of data due to protrusions and other surface imperfections tends to be reduced relative to losses encountered using previously known scanners. The raw data produced according to the time-division multiplexing functioning of the inventive scanner in a sawmill context is suitable for the determination (using suitable complementary software) of the location of branch stems and catfaces (for example) on scanned logs.

Time-division multiplexing can be used for other purposes. For example, in a board scanner the light projected onto the board is multiplexed so that in one half-cycle, a suitable de Bruijn or other selected coded pattern is projected, and in the other cycle, a fan of light is projected. In many cases it will be possible by identifying the positions in space at which the defect-caused bright/dark transitions occur, to identify precisely the beginning and the end of the defect, and from the gray-scale image, to learn something of its nature.

In board scanning and scanning of similar target objects having generally relatively uniform reflectivity but occasional defects, such as knots in the case of a board, it is advantageous in accordance with another aspect of the invention to process both light intensity data and reflectivity data in order to balance or compensate the distance data for target points in the vicinity of the defect. For example, a series of mark/space symbols of a de Bruijn or other suitable pattern can be projected onto the target object in one half-cycle of each scan, and associated reflection data are obtained that are representative of the intensity of light reflected at each pixel address in a given range spanning the surface defect. The marks are, as per the teachings of the prior Hermary patents, characterized by two or more different duty-cycle values for purposes of mark recognition and identification. Another set of reflection data are obtained during the second half-cycles of the scans as reflectivity data representative of the surface reflectivity of the scanned surface of the target object at each pixel address in the range. The second-half-cycle scans may be for the purpose of generating a gray-scale image of the target object. The light intensity data may be balanced or compensated using the reflectivity data so as to reduce or mitigate duty-cycle distortion of mark-related data induced by surface anomalies such as knots on the target object surface. Note that this aspect of the invention is not dependent upon having two cameras nor upon having two projectors; the compensation technique could be implemented using a single-projector single-camera scan head.

Further variants of the invention are possible. For example, the projectors might project a two-dimensional coded pattern onto the surface to be profiled. The cameras would in that case be two-dimensional detectors. A single “snapshot” of the log rather than the construction of the log surface profile from a series of line profiles would then be possible. As another example, one could devise scan heads having more than two cameras or more than two projectors, or both. Some increase in the reliability of data would be expected, albeit at greater expense and with greater complexity. As a further example, the coding used could be color coding or phase coding rather than mark/space brightness coding.

As mentioned, the preferred embodiment of a scan head according to the invention comprises two projectors and two cameras coplanar with one another, the two cameras bracketing the two projectors, as described above. Such apparatus is considered to be likely to be satisfactory for industrial scanning use in sawmills and similar production facilities. One may economize somewhat by eliminating one of the two projectors while keeping the two spaced cameras, with some loss of received signal reliability while obtaining some of the advantages of the present invention. Note that if one uses a single projector with two spaced cameras, there are two available signal range constraints that can be imposed on the received signal, one from each camera. But when one adds a second projector, the two projectors preferably operating in time-division multiplex as discussed above, the reception by the two cameras of the signal reflected by that extra projector generates two more available sets of data, and in some cases, two more sets of signal range constraints that can be imposed on the received signal. In other words, by adding a second projector, one doubles the number of available range constraints, and that tends to facilitate selection of more reliable data than would be possible if only one projector were used. In applications such as log scanning, a principal advantage of using a second coded projector is to obtain the benefit of a different set of projection angles and associated camera views, thereby eliminating most if not all occlusion problems such as those caused by catfaces and branch stems.

An advantage of the apparatus of the preferred binocular embodiment of the invention over some previously known apparatus is the ability to use relatively few lasers in suitable coplanar configurations to illuminate the surface of the object to be scanned while obtaining high point density of the points that together simulate the profile of the scanned object. As laser failure can mean expensive down-time for repair or replacement, it is advantageous to minimize their number. Since laser and other failures are inevitable from time to time, it is desirable to design and build self-contained modular scan heads according to the invention units that can be quickly and easily replaced.

How the received reflection data are processed, and in what sequence, are in the discretion of the signal processing system designer, end user, or systems integrator. For example, for any given series of pattern elements, the data to be selected for processing comprises (1) first projector, neighboring camera; (2) second projector, neighboring camera; (3) first projector, remote camera; (4) second projector, remote camera. Parallel or delayed computation may enable all available data to be processed generally concurrently with other available data within system limits. Processing of data set (1) would be expected to give reliable pattern recognition for relatively proximate scanned object surface points, and would, within the computation accuracy limits of the small base of the triangulation computation triangle, generate distance range boundaries for the surface point in question. Processing of data set (2) would equal step (1) for surface points that are more proximate to the second projector and its neighboring camera than to the first projector and its neighboring camera. Processing of data sets (3) and (4), given the distance range constraints imposed by the scanning geometry and the computations relating to data sets (1) and (2), could involve selection of reflection data only within the range boundaries established by the scanning geometry or by step (1) or step (2) or both. The residual data could then be smaller in quantity and simpler to process, partly because the number of sequential possible pattern elements that have to be resolved and correlated in any sequence within the permitted range is likely to be small relative to the number that would require resolution and correlation using prior Hermary apparatus, thereby permitting a lower-level de Bruijn code to be evaluated for any given pattern subset of received signal data by narrowing the search space in which acceptable data may be found.

If two or more pattern elements in any given data compilation remain to be resolved within any given bounded range, the general methodology for resolving, verifying, correlating and extrapolating received data could otherwise, apart from the helpful range constraints provided by the present invention, be generally consistent with the data processing methodology used in association with the prior Hermary apparatus. In some cases, the range constraints established using the present invention may be sufficiently rigorous that for any doubtful point, only one possible pattern element could exist within the range, in which case that pattern element, if detected at all, will have been uniquely identified without the need to resort to the prior Hermary methodology. Note that depending upon the quality of the data, an iterative approach or a buffering approach or both may be useful for processing data representing a sequence of several pattern elements, or representing successive sequences of two or more pattern elements, in order to resolve the data. This last suggestion implies that the data processor should include buffer memory suitable to store data in proper sequence over a sufficient series of scanning cycles (in other words, to build a data history) such that resolution of ambiguous or doubtful data can be attempted with reasonable chances of success.

Although distance computation using the triangulation principle is previously known, the present invention affords the possibility of optimizing triangulation calculations. As discussed, the known side of the triangle should be as long as possible for highest resolution of distance. This objective must be balanced against the objective of avoiding too long a “reach” of the coded beam in far-view imaging. In board scanning, these objectives are best realized by employing a bank of aligned end-to-end scan heads. In log scanning, the bracketing of the projectors by the detectors tends to optimize the results. This bracketing affords a further possibility according to the invention, viz using as the known side of the triangulation triangle the straight line joining the focal points of the two cameras. This can be done when the processing of the reflection data has determined that for a given item of distance data, both cameras are looking at the same point on the log. Since the two camera angles (relative to the known side) are known for the respective pixels of the CCD arrays (say), the triangulation computation can be made using a known triangle side longer than the triangle side available using a camera-to-projector baseline.

Other features and advantages of the invention will become apparent from the following detailed description and the appended claims.

### BRIEF DESCRIPTION OF THE DRAWINGS

FIG. 1 is a ray trace diagram for a representative dual-projector dual-camera arrangement for use in apparatus in accordance with a preferred embodiment of the invention.

FIG. 2 is a schematic side elevation section view of a scan head having two projectors for illuminating a scanned object, here represented by a log, and two cameras to receive and detect light reflected from the surface of the scanned object, in accordance with the invention.

FIG. 3 is a schematic isometric drawing of four scan heads of the type illustrated in FIG. 2, arranged in coplanar configuration at the quadrants of a circle around the periphery of a log.

FIG. 4 is a schematic perspective drawing of four scan heads each of the type illustrated in FIG. 2 and arranged in a linear configuration to determine the surface profile of a representative sawn board, here showing wane.

FIG. 5 is a schematic block diagram of the internal architecture arrangement for a four-head terminator control card in combination with a four-scan-head coplanar array of dual-projector dual-camera scan heads generally correlatable with the array illustrated in FIG. 3.

FIG. 6 is a schematic block diagram of the internal architecture arrangement for a four-head terminator control card in combination with an eight-scan-head board scanner array of dual-projector dual-camera scan heads generally correlatable with the board scanner array illustrated in FIG. 4. The single four-head terminator control card illustrated controls only four of the eight scan heads.

FIG. 7 is a schematic block diagram of a combination of two four-head terminator control cards of the type illustrated in FIG. 6 shown in combination with an eight-scan-head board scanner array of dual-projector dual-camera scan heads generally correlatable with the board scanner array illustrated in FIG. 4. The two four-head terminator control cards together control all eight scan heads.

FIG. 8 is a graph representing a suitable timing sequence associated with the four-head terminator control card of FIG. 5 used in conjunction with the four-scan-head coplanar array of FIG. 3.

FIG. 9 is a graph representing a suitable timing sequence for the four-head terminator control cards of FIG. 7 used in conjunction with the board scanner array of FIG. 4.

FIG. 10 is a schematic drawing showing a pattern of light and dark bands for a (2,6) de Bruijn pattern together with its boolean representation, suitable for coding the light projected by a projector used in the scan head of FIG. 2.

FIG. 11 is a series of three graphs showing (i) the output voltage signal from a camera in the scanner of FIG. 1 that corresponds to a representative reflected light signal received by the camera; (ii) a corresponding differentiated signal; and (iii) a corresponding logic diagram showing a corresponding sequence of detected edges, each of which latter two graphs is obtained by processing the signal of the graph above it. The abscissa of each graph is the same selected sequence of pixel addresses.

FIG. 12 is a series of two graphs, the upper one of which shows ideal and typical representative mark-to-space ratios of a coded pattern symbol sequence containing each of the 69 elements of a typical (2,6) de Bruijn pattern in the reflected pattern signal received by either of the cameras of FIG. 2, and the lower one of which is a plot of the values for the sum-of-squares calculated for the aforementioned sequence, illustrating a preferred least-squares matching technique for locating the best fit of a representative sample of the received signal with the corresponding portion of the full projected sequence.

FIG. 13 is a flow chart representing the manner in which the received reflection data signal is processed according to a preferred method of implementing the invention, in order to confirm that the signal detected corresponds to a scanned object profile point within the detector field of view and to generate the appropriate coordinates of such point in the X—Y plane.

FIG. 14 is a schematic side elevation section drawing of the scanner of FIG. 2 operating in one of two possible “near view” modes.

FIG. 15 is a schematic side elevation drawing of the scanner of FIG. 2 operating as illustrated in FIG. 14 but also showing the “far view” imaging by the camera remote from the operating projector.

FIG. 16 is a simplified schematic diagram of a portion of the scanner of FIG. 2 with housing removed, schematically illustrating all four scanning sectors for the arrangement (but superimposing in the drawing the scans for the two projectors, ignoring time-division multiplexing).

FIG. 17 is a partial profile of a log with a branch stem.

FIG. 18 is a partial profile of a log with a catface scar.

FIG. 19 is a schematic ray trace diagram showing transmitted and received rays for the operating projector/camera pair of FIG. 2, shown operating in the “far view” imaging mode.

FIG. 20 is a ray trace diagram for a selected projector and camera of the preferred embodiment of FIG. 2, operating in the “near view” mode.

FIG. 21 is a composite diagram showing a local ray-trace diagram in the vicinity of a surface anomaly on the scanned object and a correlated range of camera pixel addresses, and complementary thereto a series of three graphs showing respectively light intensity, target surface reflectivity, and compensated image data over the same range of pixel addresses.

FIG. 22 is a specimen two-dimensional pattern composed of a rectilinear array of marks and spaces characterized by de Bruijn pattern element sequencing, for use in a variant of the invention in which a two-dimensional pattern rather than a one- dimensional pattern is projected.

### DETAILED DESCRIPTION

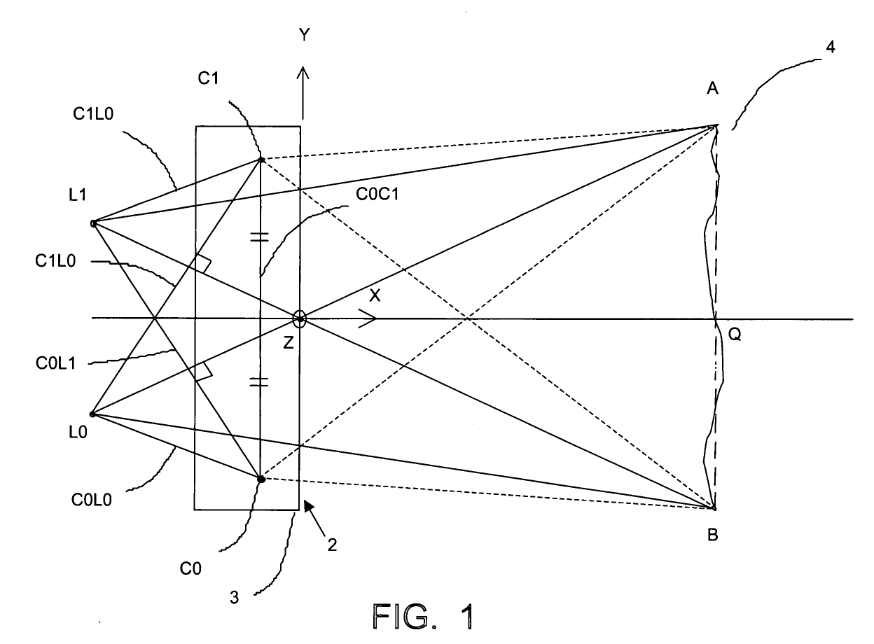

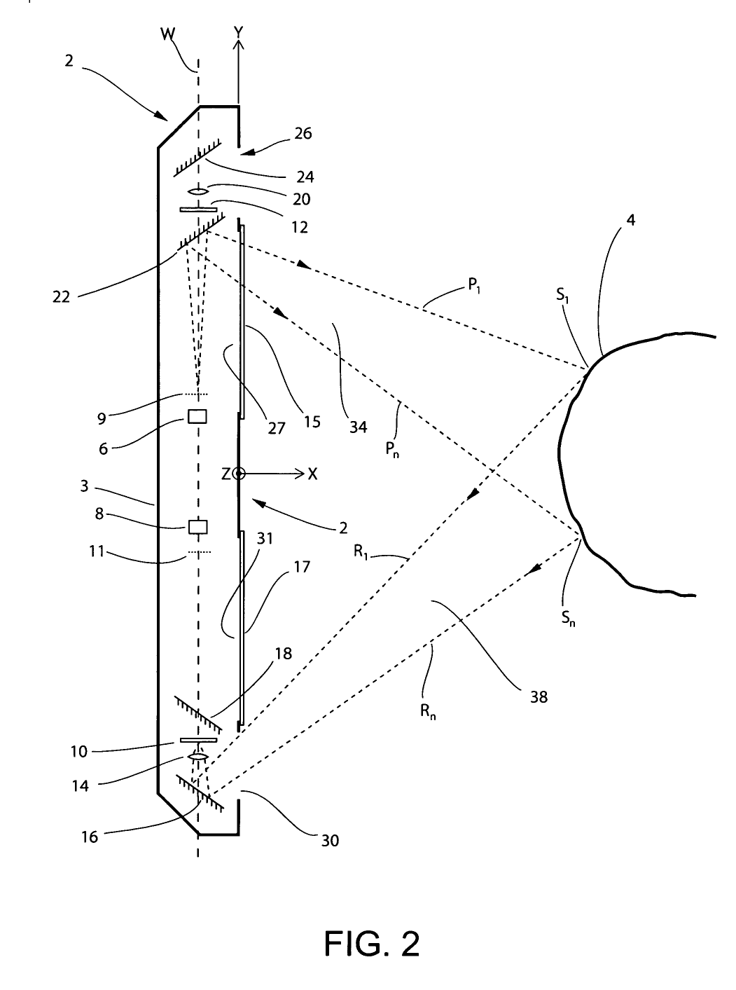

FIG. 1 schematically illustrates a ray trace diagram, manifesting the underlying trigonometric relationships of the optical elements and paths illustrated. It may be presumed that the entire assembly within the housing 3 constitutes a coded light dual image scan head 2 in accordance with a preferred embodiment of the present invention. At each end of the arrangement along the Y-axis as illustrated are detectors C0, C1 respectively. Behind the coded light dual beam scan head are two virtual laser focal points L0 and L1. While in the actual configuration the laser projectors would be physically within the coded light dual beam scan head, for the purposes of this diagram their virtual locations, determined by their respective optical paths, are located outside the box 3. The reason for the foregoing is that in a typical practical arrangement, for space-saving reasons, the optical path is folded by means of suitable mirrors, not shown in FIG. 1, but see FIG. 2 to be described below.

In FIG. 1, triangulation triangle sides and projected lines are solid, while their associated reflections are shown in phantom. Rays L0 A and L0 B can be seen projected from their respective virtual laser projection focal points at L0 to limit points A and B on the periphery of scanned object 4 at the limits of the projected beam from laser L0. In the preferred dual projection mode, a second virtual laser projection focal point L1 would project rays L1 A and L1 B.

Between rays L0 A and L0 B is an area known as the projection beam sector for L0. A similar projection beam sector can be established from virtual laser projection focal point L1 between rays L1 A and L1 B. Within the virtual laser projection focal point beam sectors, a target object, whose partial periphery is schematically illustrated by an irregular line 4 in FIG. 1, would be located at an expected approximate distance from the scan head 2. The incident beam projected individually by either projector L0, L1, onto the scanned object, would span the distance between points A and B. An individual ray projected onto the scanned object surface at point A would be reflected.

The usual trigonometric principles may be used to compare angles or distances of the various sides of triangles in the ray trace diagram. Thus, an angle of projection will be known by virtue of the design of the projector within the scan head; and the reflected signal will be detected by cameras C0 and C1, using a pixel address if, as is preferred, the cameras each comprise a CCD array. Baseline lengths may then be computed for C0L0, C1L0 and C0C1, when one projector is used. If two projectors are used, then additional baseline lengths may be used (viz C0L1 and C1L1). Once the trigonometric relations are established, it is rudimentary to identify all lengths and angles associated with all triangles in the ray trace diagram. Of particular interest will be the distance x of the scanned point A from the scan head, or more precisely from the Y-axis. Since the y coordinate value is related directly to the angle of projection, that value is a function of the projector design. In a preferred embodiment of the invention, the y coordinate value determined by the angle of projection is related to the masking system to be described below, which allows a fan shaped coded beam to be projected.

It will be noted that the coordinate system manifested in FIG. 1, with the -origin chosen to be at the midpoint of the surface of the scan head 2 nearest the scanned object, is in accord with convention. The X-axis is perpendicular to this surface and extends linearly to the right in the illustration. The Y-axis is parallel to the aforementioned scan head surface and projects at right angles to the X-axis; conveniently the Y-axis may lie in the plane of the scan head surface. Together they form the X—Y plane, which lies in the plane of the illustration. The Z-axis extends perpendicular to the X—Y plane, toward the viewer, and is parallel to the direction of motion of the scanned object. (Alternatively, the object could be stationary and the scan head 2 could move in the Z-direction.)

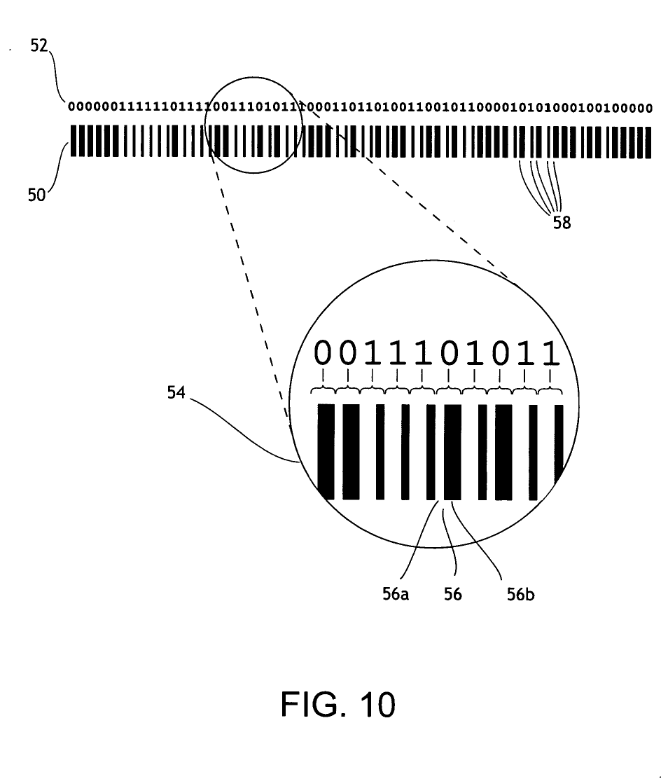

FIG. 2 illustrates schematically a representative scan head 2 constructed and operable according to the invention, for scanning a portion of the surface of a log 4 shown only in partial surface profile in the illustration. The log 4 moves in a direction orthogonal to the X—Y plane. The operating components of the scan head 2 are housed in a suitable housing 3 closed to light except at windows (or apertures) 26, 27, 30 and 31. Unless masked, windows are usually preferred to apertures in order to prevent dust from entering the housing 3; but care must be taken to avoid unwanted refraction or reflection from the windows. To that end, to keep the internal components of the scan head 2 free of dust and debris, the apertures 26 and 30 should be covered by transparent glass or the like; in other words, they should be closed but transparent windows. The apertures 27, 31 are covered and in large measure occluded by mask plates 15, 17 that each carry a partially transparent mask pattern formed by alternating bright (transparent) and dark (occluded) bands, as discussed in more detail below with reference to FIG. 10. Alternatively, the pattern masks could be located internally within the housing 3 in the positions identified by phantom lines 9, 11. The housing 3 is preferably made of a strong, durable material that is tolerant of rough treatment. The housing 3 forms a closed structure that is preferably sealed to stop water penetration, and apart from the mentioned windows and/or apertures, is opaque to light.

The operating components of scan head 2 include two spaced laser projectors 6 and 8 and their associated mirrors 22, 18 suitably chosen to reflect and transmit through the masks 15, 17 the beams from projectors 6 and 8. The projectors 6 and 8 operate alternately, as will be discussed in more detail below. In FIG. 2, laser 6 is shown operating, casting its projected beam between beam sector angular limits P1 and Pn within a beam sector 34. Bracketing the projectors 6 and 8 and aligned with them parallel to the Y-axis within the housing 3 are two spaced cameras 10 and 12 and their associated mirrors 16 and 24, and associated camera focusing lenses 14 and 20 selected to focus the received image onto the cameras 10 and 12. In FIG. 2, with laser 6 operating, that received image is the image reflected from the projected beam between points S1 and Sn on the scanned log 4, and within view sector 38 lying between view sector angular limits R1 and Rn. The masked apertures 27 and 31 respectively pass and code light from projector 6 and projector 8, via associated mirrors 22, 18. The apertures 30, 26 are open to incoming light that reaches cameras 10, 12 via associated mirrors 16 and 24. The internal optical components of the scan head 2 are preferably physically aligned along notional line W to maintain the requisite coplanar relationship of these elements in the X—Y plane. Note that the total optical path from any given operating component of scan head 2 to any given point on the log 4 comprises not only the portion of the path external to the associated aperture but also the reflected portion of the path within the housing 3. In other words, the virtual sources L0, L1 of laser light are as illustrated in FIG. 1, and, apart from the camera-to-camera baseline possibility discussed elsewhere in this specification, each such virtual source constitutes one end of the triangulation base for triangulation distance computations, as will be discussed further below.

Prior to use, the scan head 2 should be calibrated so that all required basic data are ascertained and all required correlations are established, so that measurements and computations will be based on reasonably accurate foundations, within selected engineering tolerances. For example, camera view angle should be properly correlated with camera pixel address, and baselines for triangulation computation should be ascertained. Empirical testing of the scan head 2 can be done to satisfy the user that it is in good working order.

The projectors 6 and 8 are preferably commercially available lasers of the general sort described in the prior Hermary patents, or upgrades thereof. The cameras 10 and 12 are preferably commercially available CCD cameras comprising an aligned array of CCD detectors, of the general sort described in the prior Hermary patents, or upgrades thereof. The projectors 6 and 8, when operated, project a coded light beam determined by the coding on the respective masks 15, 17 respectively (or alternatively masks 9 and 11 respectively), but the coding could be otherwise imposed on the light beam as discussed in the prior Hermary patents. The projector 6, camera 10, and associated mirrors 22, 16 and lens 14 comprise a Hermary scan head of the sort described in the referenced Hermary patents. The other projector 8 and camera 12 and associated mirrors 18 and 24, and lens 20, constitute another Hermary scan head of the sort described in the referenced Hermary patents. However, these two Hermary subsystems do not function merely as such, but function as part of a completely integrated scanning system, as will be described.

For reasons previously presented, it is advantageous to have the cameras 10, 12 located as the outermost components along the line of optical alignment, bracketing the projectors 6 and 8. It is also advantageous, for reasons also previously described, to have the camera 12 located fairly close to projector 6 and to have the camera 10 located fairly close to projector 8, but to maintain a reasonably large spacing between the two projectors 6 and 8. It is convenient for purposes of design and triangulation computation to construct the two Hermary subsystems identified above as mirror images of one another, so that the distance between projector 6 and camera 10 is identical to the distance between projector 8 and camera 12, and so that the distance between projector 6 and camera 12 is identical to the distance between projector 8 and camera 10. The distance between projector 6 and camera 10 is selected to be long enough that the triangulation baseline there between is able to support a reasonably accurate calculation of the distance between a scanned point on the surface of the log 4 and the notional line W, or from the Y-axis, or any other line or plane parallel to the Y-axis, as the designer chooses. The distance between projector 6 and camera 12 is selected to be long enough for convenience of manufacturing, but is kept short enough that an incident ray of light projected onto a proximate portion of log 4 is reflected back with a small angle of separation between the incident and reflected rays. Light baffles (not illustrated) or other light barriers may be provided within the housing 3 as required, to minimize the chance that spurious light from the projectors 6, 8 will reach the cameras 10, 12 via an internal path.

In the operation of the scan head 2, it is advantageous to use time-division multiplexing for the light projection; in other words, to alternate the operation of projectors 6, 8 cyclically so that only one projector at a time illuminates the scanned object, here the exemplary log 4. It is advantageous to have both cameras 10, 12 operating when either of projectors 6, 8 operates, so that two discrete reflected beams are detected, one by each camera 10, 12, thereby to obtain two separate data signals for each scan, one from each camera. However, for purposes of illustration and explanation, it is convenient first to examine the projection and detection of radiated light by a single projector, by way of example the projector 6 in FIG. 2, and by a single camera, by way of example the camera 10 in FIG. 2. But it should be borne in mind that although reception and detection of the radiated light beam is illustrated only for the camera 10 in FIG. 2, nevertheless the camera 12 will in preferred operation also be operating simultaneously and will generate its own output signal representing the reflected pattern data as received by it. (Compare FIG. 15.)

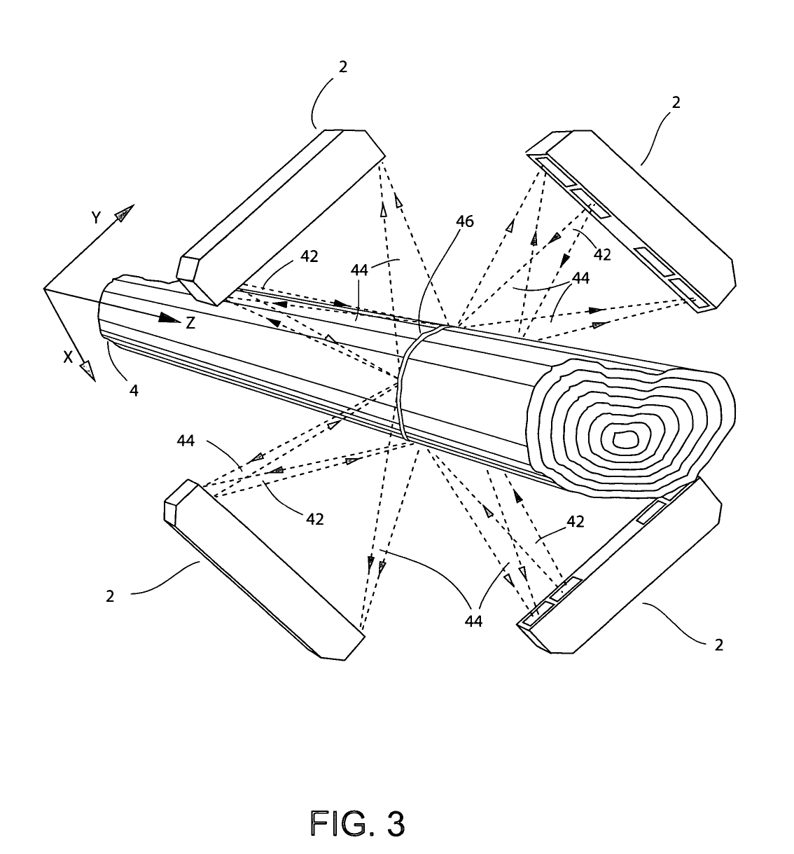

Limiting the discussion for the moment to what is illustrated in FIG. 2, a beam of light 34 emerges from the projector 6, is reflected from the associated mirror 22, and is thereby directed through a code-masked aperture 27 toward a portion of the object to be profiled, here log 4. To enable the beam 34 to span a suitable arc, the original laser beam may be passed through a diverging lens (not shown). In a representative sawmill environment, the beam thickness could be selected to be approximately 0.1 cm (0.04″). The distance of the scan head 2 from the object to be profiled, here log 4, the lens characteristics and other optics, and the sizes of the apertures 26, 27, 30 and 31 are chosen so that the illuminating beam 34 covers approximately a quadrant of a circle generally coincident with the periphery of the log such that the entire target object can be scanned by four scan heads mounted at 90° separation around the periphery of the log 4, as described in the Hermary '745 patent and as illustrated in FIG. 3. The illustration of FIG. 2 shows an illumination of the log 4 that is somewhat less than the suggested 90° coverage of the log periphery, which indicates that either the layout should be redesigned to permit the beam 34 to cover a wider angle, or alternatively (but not normally preferred), more than four scan heads could be mounted around the periphery of the log 4 so as to provide complete coverage of the periphery. Experience with the scanner of the Hermary '745 patent indicates that four scan heads located in a coplanar array in quadrants about the log 4 give generally satisfactory results, and the increased number of useful data sources available pursuant to the present invention may permit a reduction in the number of scan heads employed to three spaced at 120° intervals about the log 4, or for some purposes, possibly two scan heads, one on either side of the log 4.

The angular limits of the projected beam 34 correspond to the limits P1, Pn of projected pattern elements (symbols) P1 to Pn of a pattern of dark and light bands superimposed on the beam 34 by mask 15 or equivalent. The masking technique is generally similar to that described in the prior Hermary patents. The mask 15 could be alternatively mounted on the interior side of the housing 3 or lithographed on a glass plate through the transparent portions of which the projected beam 34 passes.

The projected pattern strikes the log 4 along a log profile line lying between pattern image limit points S1, Sn on the periphery of the log 4. The surface of the log 4 is presumed not to be perfectly smooth, so light is reflected and scattered back in many directions from the surface. However, the camera 10 has a limited viewing angle; that portion of the reflected image represented by reflected image view 38 can be sensed by the camera 10; light from the reflected pattern falling outside image view 38 cannot be detected by the camera 10. The reflected pattern image is bounded by reflected symbol rays R1, Rn corresponding respectively to projected pattern limit rays P1, Pn. The detectable reflected light within the image view 38 passes through the apertures 26 and 30, each of which directs the received light with a mirror (16 or 24) and imaging lens (14 or 20) arrangement onto a camera (10 or 12). The light falling on each camera 10 or 12 produces voltages on the photosensitive elements of these cameras proportional to the intensity of the incident light on these elements.

The log 4 is moved along its path of travel parallel to the Z-axis by conventional mechanical means that are not illustrated. A shaft encoder or similar electro-mechanical device of conventional design (not shown) generates a shaft encoder pulse at intervals as the log 4 moves in the Z-direction. By counting these pulses, the value of the z-coordinate of each “snapshot” of the log 4, i.e. the z-coordinate applicable to each scanning cycle, can be determined.

FIG. 3 illustrates isometrically a preferred mode of use of a coplanar array of profile scan heads each constructed in accordance with a preferred embodiment of the invention. A set of orthogonal X—, Y—, and Z-axes is shown for the upper left scan head in the illustration, the Y-axis being parallel to the longer dimension of the scan head and in the plane of the projectors and cameras, the Z-axis being parallel to the path of travel of the log 4, and the X-axis being perpendicular to both the Y— and Z-axes, pointing towards the near surface of the log 4. The origin is typically chosen as lying half-way between the two cameras in the scan head in question. The foregoing convention is used in this description. Note that separate sets of coordinate axes are used for each scan head.

In each cycle of the multiplexed operation of the projectors within the scan heads of FIG. 3, each scan head 2 in timed sequence projects a discrete beam 42 onto the scanned log 4, and receives reflected pattern image light 44 back to each of two cameras in that scan head or those scan heads 2 that are currently operating. Using the apparatus and methods described in more detail below, measurements of the values of the x-coordinates for points on the surface of the log 4 are calculated for a set of y-values for each scan head 2. The combined results from the four scan heads 2 produce an estimate of the location of the thin profile band 46, illuminated by the projectors in a representative scanning cycle, that covers the entire periphery of the log 4 for a determined value of the z-coordinate. The data obtained from the cameras for each band 46 may be considered a “snapshot” of that portion of the peripheral profile of the log 4 at that z-coordinate, and the combination of all of the snapshots as the log travels past the scanner yields data from which the entire log surface profile may be determined. Depending upon layout, etc. it may be desirable to time-multiplex the operation of the scan heads 2, so that each operates in sequence, or else opposed pairs may operate alternately. Note that with time-multiplexing, the band 46 will be subject to slight interruptions and offsets as the scan heads 2 operate in sequence.

The detector cameras could conceivably remain active throughout, recording received reflected signals with a time index. However, it tends to be more efficient from a data processing standpoint to have the cameras each sense and integrate the reflected image data only while a laser is projecting light onto the target object that can be received by such camera, and then to have the camera shut off to reflection data input for those half-cycles during which no laser is providing light to the target that is reflected back to such camera. During such latter half-cycles, data can be read out of such camera.

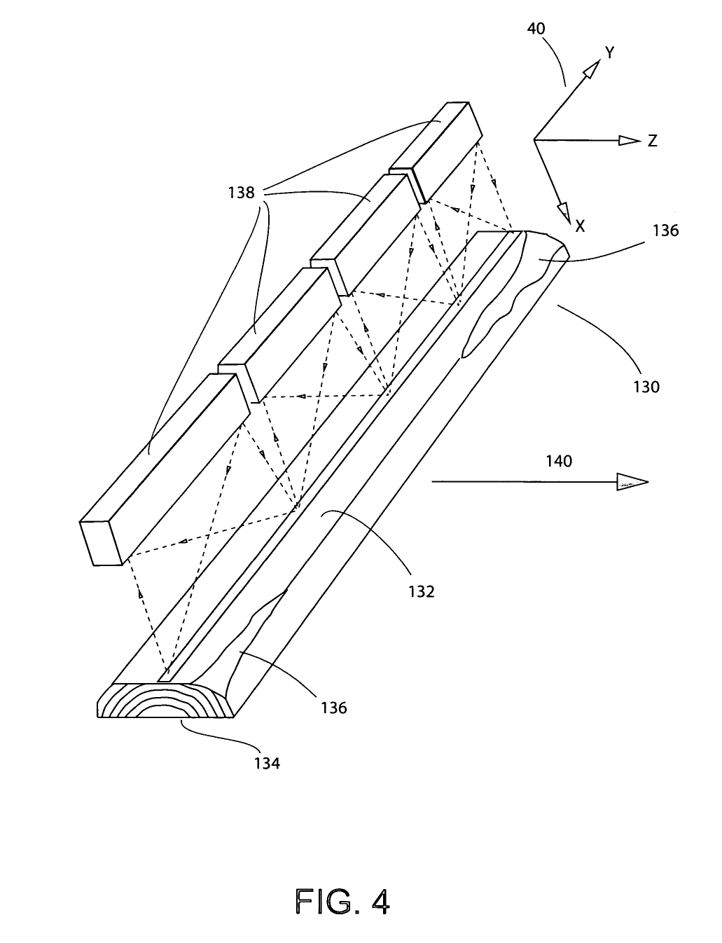

Scan heads 2 may be arranged in other configurations for other purposes. In FIG. 4, a partially sawn board (cant) 130 has two faces 132 and 134 (the latter not visible in the illustration) that have already been sawn, and two portions 136 rendered unusable by wane. In order to optimize the cropping or further sawing of such a board, it is important to have an accurate estimate of the profile of the surface 132. For this purpose, four scan heads 138, each of which may be substantially identical to the scan head 2 of FIG. 2, are spaced evenly along the length of the cant 130, parallel to the Y-axis. The number of scan heads 2 in an array will depend upon the length of each scan head, the length of the board or other object scanned, and the desired scanning resolution. In a single scanning cycle, if each projector mask employs a (2,6) de Bruijn pattern, so that the pattern is projected by the collectivity of scan head projectors onto the surface 132, 256 points can be measured along the sawn face 132 of the board, parallel to the X-axis. A complete profile of the surface 132 is compiled by repeating the scanning cycle as the cant is moved in the direction indicated by the arrow 140, parallel to the Z-axis. In a typical installation, a second set of scan heads 2 (not shown) may be positioned in a mirror image of the array of scan heads 138 to scan the undersurface 134 of the cant 130. Again, time-multiplexing of the scan heads can be used to minimize the interference between scan heads. While, as in the prior Hermary patents, a (2,6) de Bruijn pattern may be used, for the reasons expressed elsewhere in this specification, a lower-level de Bruijn pattern or modified symbol subset thereof may instead be selected.

It is desirable when profiling a cant such as the cant 130 to be able to detect the precise location and inclination of its end cuts. Data representative of the end face angles can be used in a sawmill to adjust the positioning of pin contacts abutting the end of each cant as it is positioned for sawing, so that each cant is brought into proper alignment with the saw. Careful selection of the saw position can sometimes mean the difference between a standard-length board and one that has to be designated sub-standard as too short. The projection of the de Bruijn coded pattern enables the position in space of the cant 130 to be ascertained for each z-coordinate at which a scan is made. Note that precise data will be more reliably obtained for this implementation of the invention if the cameras are positioned close to the surface to be scanned, especially in relation to end-of-cant edge detection using the single-light sheet projection and reflection. However, the positioning of the cameras must also be consistent with selected optics and selected scan zone design parameters.

Further, knots and other defects in boards can be identified with the combined operation of the distance scan (coded light projection and pattern reflection) and gray-scale scan. To this purpose, the light projected onto the cant 130 by each scan head 138 could be multiplexed so that in one half-cycle, a suitable de Bruijn coded pattern (say) is projected, and in the other half-cycle, a continuous uncoded fan of light is projected. If a portion of the cant 130 free from defects is being scanned, both the distance measurement and the gray scale image are likely to be generally regular and uniform. On the other hand, if a portion of the cant 130 subject to a defect is being scanned, there will typically be points at which the regular and uniform signal comes to an end, sometimes an abrupt end, and/or a spatial shifting of the points, such points being those at which wane or a knot or some other defect begins or ends. Both distance and gray-scale data may help to identify what sort of defect exists.

Note that gray-scale imaging will typically suffer from parallax distortion, particularly in the far view. However, the pixel addresses will be known for given gray-scale brightness values, so it is relatively easy using conventional software techniques to remap the pixels so as to space them evenly from one another for each scan, thereby to generate a gray-scale image substantially free from parallax distortion. Such distortion-free imaging may facilitate recognition of the type of defect in a given area of the board, say, and may afford more precise identification of the spatial limits of the defect. Further, conventional software techniques are available for rotating and combining images; if views of both sides of a board, say, are available, it may be advantageous to examine an apparent defect from different viewpoints to facilitate identification of defects and the spatial extent of the defects.

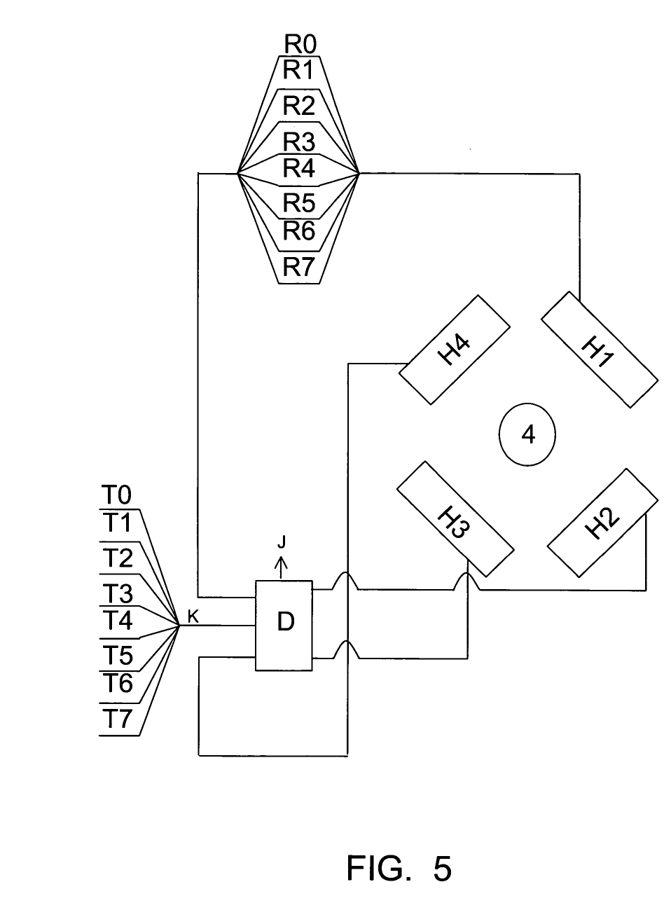

FIG. 5 shows schematically a block diagram of the internal architecture associated with a synchronizing/encoding four-head terminator control card D for the coplanar scanning arrangement of FIG. 3. The controller card D is connected to the various scan heads H1, H2, H3 and H4 corresponding to the set of four scan heads 2 of FIG. 3. Various input signals T0 to T7 from, say, a microcontroller, control the successive activation of each laser projector and detector camera within each scan head. These signals control the generally helical composite scan of the log 4 or other scanned object. The card D is preferably also connected via one or more connections J to in an Ethernet configuration (not shown) to permit data exchanges with other parts of the controlled production line, not shown. For example, such connection would permit the controller to further synchronize scan cycles with those of other scan head arrays, enabling a faster scanning period for the entire log length. For example, rather than operating only one scan head or array of scan heads at a time, two or more scan heads or arrays could operate. If two arrays were used, then each scan head array need scan only half of the entire log length.

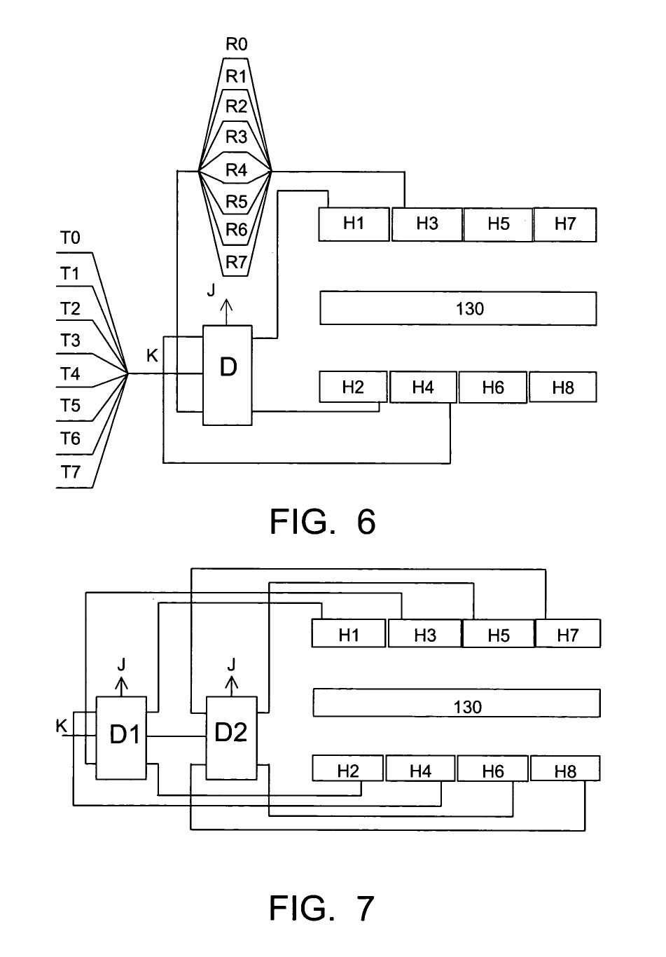

FIGS. 6 and 7 should be considered together. Assuming that a single controller card is suitable for controlling a maximum of four scan heads, then if the scan head array of FIG. 4 were duplicated to scan the undersurface 134 of the board 130, eight scan heads altogether would be needed for the task. Accordingly, two controller cards would be needed for the complete board scanning apparatus. FIG. 6 illustrates schematically the control architecture for one of the two cards, and FIG. 7 illustrates the combined architecture for both cards.

Specifically, the four-head terminator control card D1 illustrated in FIG. 6 controls scan heads H1 through H4 of the eight scan heads H1 through H8 of the complete board scanning apparatus. Note that two of the scan heads H1, H3 connected to and controlled by control card D1 are arranged in a linear array on one side of the board 130 and the other two such controlled scan heads H2, H4 are on the other side. The board 130 is presumed to move in a plane perpendicular to the view of FIG. 6. Suitable input signals P0 to P7 control the successive activation of each controlled laser projector and input signals R0 to R7 control the successive activation of each controlled detector camera within each scan head, but only four of the respective input signals of each type operate control card D1; the other four of each type operate control card D2 of FIG. 7. It will be noted from FIG. 7 that control card D2 controls scan heads H5, H7 on one side of board 130 and H6, H8 on the other side of board 130. The complete set of signals control the combined succession of scans. Again an Ethernet configuration (not shown) may be connected via connections J one or more to each control card D1, D2 to permit data exchanges with other parts of the controlled production line, not shown. Note also that the entire board scanning architecture, comprising scan heads and control architecture, may be duplicated so that one set of scanning apparatus scans one half of the board or other target object and the other set scans the other half of the object.

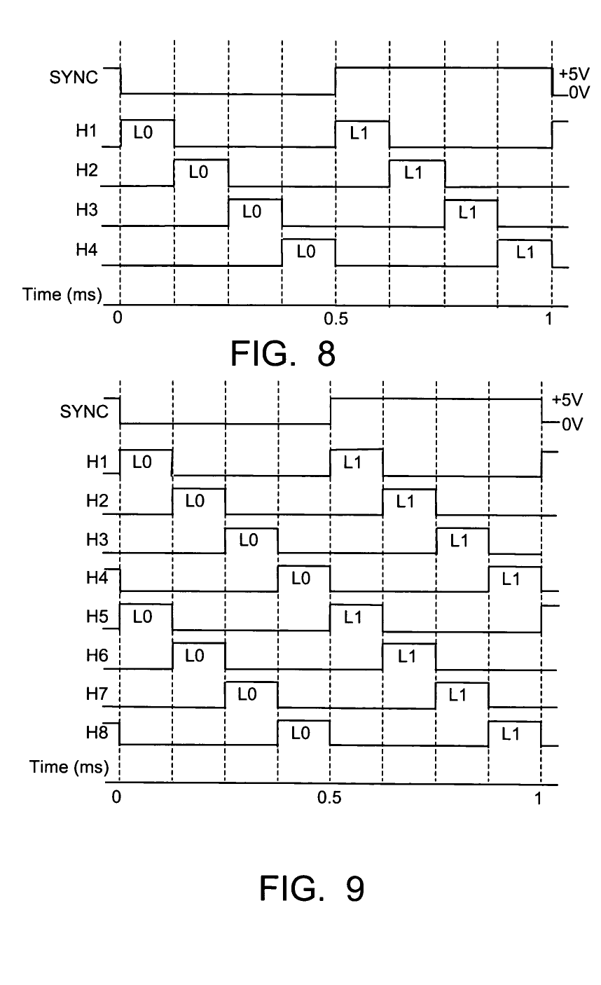

FIG. 8 shows a logic graph illustrating the timing sequence for the four-head terminator control card in the log scanner configuration of FIG. 5. The ordinate represents square-wave manifestations of the respective synchronizing logic signals and the abscissa represents time. A synchronizing clock pulse (top signal) switches to logic positive about every 0.5 ms. During each 0.5 ms period of synchronizing clock pulse zero, the first laser L0 in the four scan heads H1 to H4 will be successively activated for about 0.125 ms. During each 0.5 ms period of synchronizing clock pulse one, the second laser L1 in each of the four scan heads will be activated for about 0.125 ms successively. The detector cameras are active throughout, recording received reflected signals with a time index. The entire scan cycle is thus helical-like in its time-division multiplexing character as it sweeps the periphery of the scanned log from one end to the other.

FIG. 9 shows a logic graph similar to that of FIG. 8 representing the timing sequence for the two four-head terminator control cards in the board scanner control architecture configuration of FIG. 7. Again a synchronizing clock pulse (top plot) switches to logic positive every 0.5 ms. During each 0.5 ms period of synchronizing clock pulse zero, the first laser L0 in the four scan heads H1 to H4 and the four scan heads H5 to H8 will be successively activated for 0.125 ms. During each 0.5 ms period of synchronizing clock pulse one, the second laser L1 in each of the four scan heads H1 to H4 and the four scan heads H5 to H8 will be successively activated each for 0.125 ms. (Note that these partial-cycle duration times, while illustrative, are subject to the designer's selection. Furthermore, the times will typically not be exact but will be governed by the clock crystals or other standard reference employed, and such crystals and associated circuitry tend not to adhere absolutely to specification, but can vary within ordinary engineering tolerances.)

Care should be taken in the positioning of the scan heads to avoid unwanted stray light from the neighboring scan heads interfering with active scan heads. Scan heads H1 and H5 are activated at the same time, with all other scan head projectors inactive (although the cameras in all may still be active). After the first 0.125 ms has passed, for the next 0.125 ms scan heads H2 and H6 are activated at the same time, with all other scan head projectors inactive. The staggered alternate scanning using pairs of scan heads continues until the first laser L0 scan is completed after time index of 0.5 ms. After time index of 0.5 ms, the entire cycle is repeated but instead using the second laser L1 in each scan head. The entire scan cycle is staggered and alternating in its time-division multiplexing character. Note, however, that because each scanner projector according to the invention projects only a line of light, coded or uncoded, which line can be as narrow as the engineering of the apparatus permits, the scanner according to the invention can be quite effective in discriminating valid signal from optical interference, as compared with other scanners that must accept as input appreciably more than a line of light.

FIG. 10 shows schematically an exemplary mask 50 for use in mask plate 15 or 17, together with a boolean representation 52 of the information it represents. A portion 54 of FIG. 10 is enlarged for ease of viewing. The mask 50 is patterned as follows, assuming that one follows the pattern design recommendations of the prior Hermary patents:

The pattern is made up of a sequence of elements, sometimes referred to as symbols. Each symbol in the sequence is made up of two adjacent bands. The first of these bands is light; the second is dark. In FIG. 10, an exemplary symbol is labeled generally as 56; its light band is labeled as 56a and its dark band labeled as 56b. A specimen series of five sequential symbols is indicated as 58.

The ratio of the width of a light band 56a to a dark band 56b is one of two values chosen to facilitate the identification of the two types of symbols. Suitably, for maximum contrast, these values are either 1:2 or 2:1—the value 1:2 indicates a light band of width 1 unit followed by a dark band of width 2 units, and the value 2:1 indicates a light band of width 2 units followed by a dark band of width 1 unit. The system is designed to interpret a 1:2 symbol as a boolean 0 and a 2:1 symbol as a boolean 1.

Suitably, the sequence of pattern elements is chosen so that any sub-sequence of a selected length, which length is determined by the designer, occurs only once within the full sequence. This is as described by de Bruijn and in the applicants' prior U.S. patents referred to above. For example, the sequence might have 69 elements as in the mask 50 and boolean sequence 52 in FIG. 10. This is a sequence in which each of the 64 possible 6-bit boolean sequences appears only once. As each element in the preferred embodiment has two states and sub-sequences of length 6 or greater are unique, this pattern is referred to as a (2,6) de Bruijn pattern. For reasons discussed elsewhere in this specification, a lower level de Bruijn pattern or equivalent or subset may be used for the practice of the present invention in at least some applications of the present invention.

The mask 50 is readily made by conventional means. The mask 50 can be created in a laser printer on a clear plastic sheet. However, for better durability and finer edge resolution, the mask 50 can be applied by a conventional lithographic technique to the surface of each of the otherwise opaque covers 15, 17 through which the projected beams emerge. A mask might alternatively use a translucent LCD screen.

The light reflected from the scanned object, e.g. exemplary log 4 in FIG. 2, is directed to one or more cameras, such as cameras 10 or 12 in FIG. 2, that use photosensitive detectors to measure the intensity of light received. A representative detector in such a camera has 2048 pixels. If, for example, the full coding sequence in the projected beam contains, say, 69 elements (symbols) and the entire beam is reflected back to the camera, each of the 138 bands (one light, one dark for each of 69 elements) is, on average, spread over approximately 15 pixels in the camera. The resulting signal from the camera is a sample of 2048 values of the intensity of the light received at the camera.

As is discussed in the earlier Hermary patents, unfavorable conditions or irregular objects can make it difficult to deduce accurately the received pattern from the voltages detected on either of the cameras 10 or 12. To do so successfully requires the accurate estimation of the pixel locations where an element of symbol of the pattern projected on the scanned object begins (a dark to light transition) and where themark ends (a second dark to light transition). In practice, the most effective way of determining the transitions is to look for large differences in the voltage values on adjacent pixels in the detectors, i.e. to detect the edges of marks and spaces. Then the duty cycle between consecutive edges can be determined from the reflection data. The prior Hermary patents include a discussion of detection and matching, including rejection of erroneous or unreliable data and methodology for matching doubtful or unreliable data.

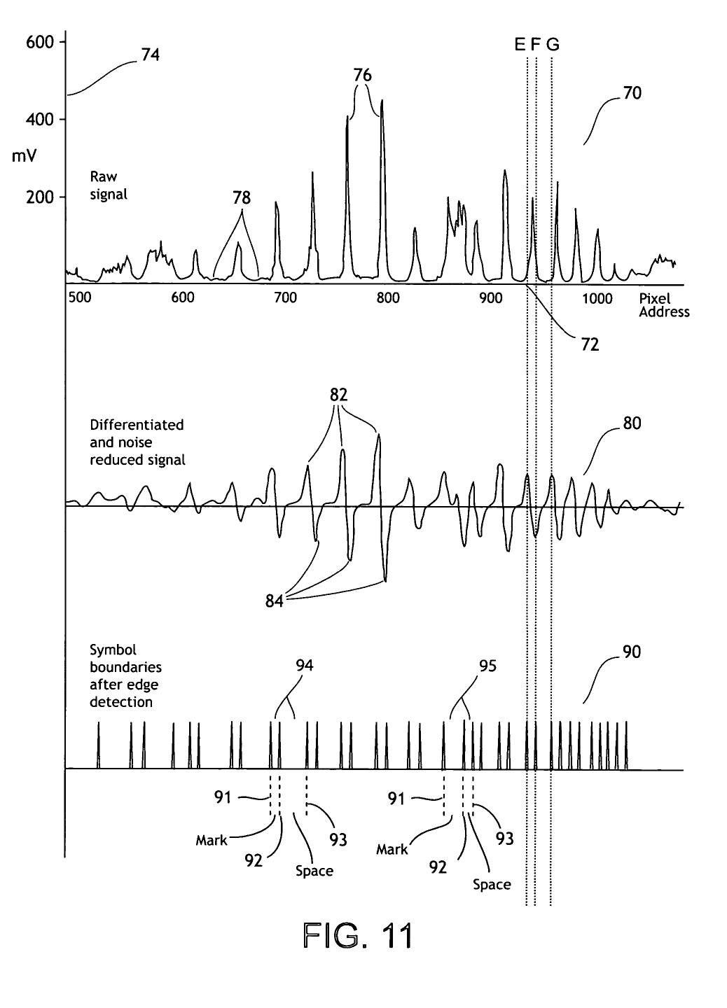

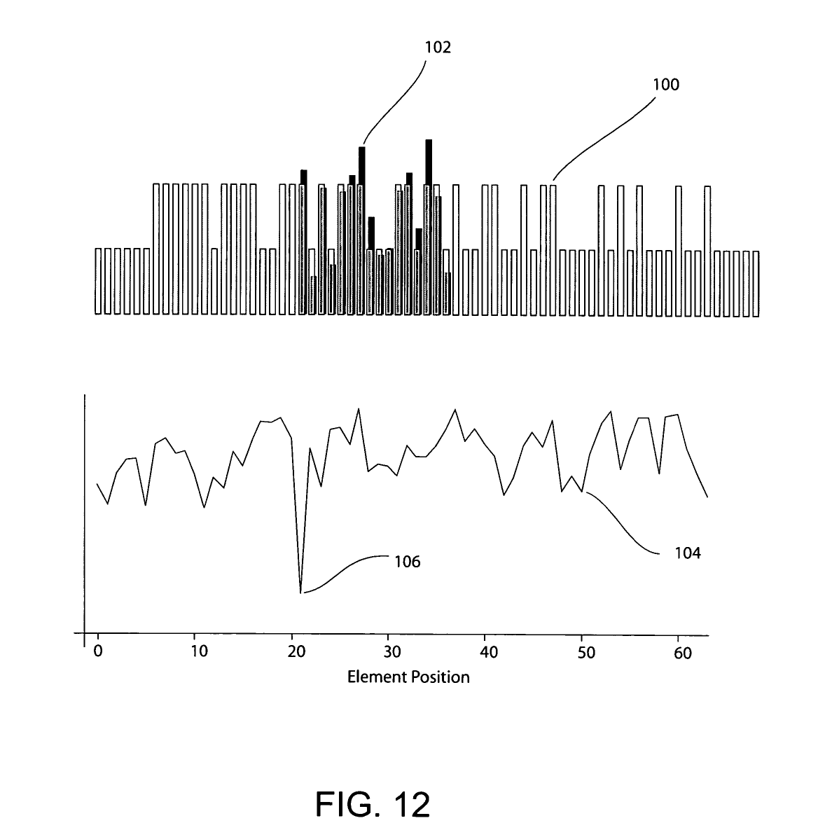

The uppermost graph 70 of FIG. 11 (labelled “Raw signal”) shows a portion of a representative signal produced by a camera receiving reflected image data from a scanned object on which a boolean pattern of the previously described sort has been projected. The abscissa along horizontal axis 72 is the pixel address in the sequence of addresses of pixels in the camera. The ordinate along the vertical axis 74 is the received signal strength in millivolts. The raw signal shows spikes 76 corresponding to image portions at which the projected beam has illuminated the object.

The central graph 80 of FIG. 11 (labelled “Differentiated and noise-reduced signal”) shows the signal over the same range of pixel addresses as for graph 70 after the signal has been processed by a standard differentiator circuit. The differentiated signal shows a repeating pattern of highs 82 and lows 84 corresponding to the points in the raw signal that have the greatest ascending or descending slope. Each high peak 82 represents a transition from dark to light and each low peak 84 a transition from light to dark. When one progresses from a positive detector voltage signal above a certain threshold to one that is below a certain threshold, one is progressing from a region that is a mark to one that is a space. Vertical lines E, F and G are for graph comparison purposes; these lines are located at the same set of pixel address for all three graphs. Note that the points of central graph 80 that correspond to the upper graph 70 represent the slopes of maximum change (positive or negative) or inflection. In central graph 80 the local maxima and minima are of interest.

The lowest graph 90 of FIG. 11 (labelled “Symbol boundaries after edge detection”) shows the location of the edges detected by way of analysis of the differentiated signal 80. The difference in the value for the pixel location corresponding to a rising edge 91 and a following (higher pixel address) falling edge 92 corresponds to the width of a mark. The difference in the value for the pixel location corresponding to a falling edge 92 and a following (higher pixel address) rising edge 93 corresponds to the width of a space. The lowest graph is a logic plot, not an intensity plot, of edge binary information, i.e. whether a given edge is a falling edge or a rising edge.

Having identified where a pattern element starts at 91 and the length of its mark and space portions, the boolean value is determined by looking at the ratio of the mark to the space. By design, if the teachings of the prior Hermary patents are applied, this should either be 1:2 (for a zero) or 2:1 (for a one). FIG. 11 shows the boundaries of two elements 94 and 95. The element labelled 94 represents a boolean 0 value and the element labelled 95 represents a boolean 1.

In accordance with one aspect of preferred practice of the present invention, the 2-symbol pattern design of the prior Hermary patents may be advantageously replaced by a 3-symbol pattern design, the third symbol being a 50%-50% duty-cycle symbol. To improve the contrast of this symbol with the other two symbols, the 67%-33% and 33%-67% symbols of the prior Hermary patents may advantageously replaced by 70%-30% and 30%-70% symbols. And, as discussed above, more than 3 different symbols could be used, but if more are used, it becomes increasingly difficult to distinguish between the symbols, and the more edges that must be detected, greater difficulty may be expected in distinguishing pattern element edges from optical interference (“noise”).

In practice, sometimes only a portion of the projected symbol sequence is recovered. This is to be expected as the spread of the projected beam sector is chosen to be large enough to span a selected angle (such as a quadrant) of the surface of the scanned object, so that at one or both limits of the scan of a relatively large object, either projected or reflected data tends to become lost or unreliable where the viewing camera is remote from the projector. When a smaller object is scanned, a portion of the projected beam necessarily passes by the target without reflection from the object.

Further, the apparatus may have to reject some portions of the received signal. This may happen as a result of poor reflectivity or occlusion that interferes with the ability of the camera to detect the projection of a portion of the pattern onto the scanned object. Where this happens, the resulting reflected image data sequence has gaps. However, if de Bruijn coding is used, by the nature of the de Bruijn coding, as long as a unique subsequence of consecutive bits is accurately recovered, that subsequence has a unique location in the original full sequence, enabling interpolation and extrapolation of reflected signal data to be made, as explained in further detail in the previous Hermary patents. Because cross-checks on the validity of data can be made using the present inventive apparatus and techniques that do not always depend on recovery of unique pattern subsets, de Bruijn coding does not necessarily have to be used to generate a useful projected pattern.

The upper graph of FIG. 12 shows the ideal values 100 to be expected for the mark-to-space ratio for each of the 69 elements from a typical (2,6) de Bruijn pattern such as pattern 50 in FIG. 10. The mark-to-space ratios of a sample of 16 received symbols is shown as sequence 102, shown in black/gray bars behind the corresponding ideal values for the full sequence 100. Note the departure of the specimen received signal voltage values from ideal values.

The general technique used to locate the sub-sequence recovered in the sample 102 within the full sequence 100, is the well-known least-squares technique. In FIG. 12, the lower graph 104 shows the values for the sum-of-squares calculated for the sample sub-sequence 102. This graph shows that the sum of squares has a minimum at a pixel address 21 labeled as trough 106. The least-squares technique can be used to establish a “seed” for initial matching, serving as a foundation for later matching of unassigned or ambiguous data.

The result of the matching process is a set of pixel locations along the detector's array that correspond to (at least some of) the patterns transmitted in the projected beam. Because of the known behavior of the optical components, each pixel location in the array corresponds to an angle between the incoming light ray and a baseline connecting the virtual projector's focal point and the camera as discussed with reference to FIG. 1. Similarly each unique sub-sequence in the projected beam is uniquely associated with an angle between a light ray in the projected beam and the baseline. Knowing the pairs of angles and the length of the baseline, a straightforward triangulation computation provides the x- and y-coordinate values that describe the location of the line profile of a fragment of the surface of the scanned object in three-dimensional space. A z-value for each of these x- and y-values is measured for that scene or “snapshot” by counting the encoder pulses generated by the conventional electro-mechanical encoder (not shown), attached to the log transport mechanism, or by some other suitable technique.

Note that if an identified scanned point on the target is visible to both cameras, and has been ascertained to be one and the same point for both cameras, the pixel address corresponding to that point in each camera will be known. Once this happens, the camera-to-camera baseline can be used as the triangulation baseline for computing the x-coordinate of the point. Since the camera-to-camera baseline is the maximum-length baseline available in the geometry of the scan head, it follows that the highest-resolution distance measurement possible for that scanned point can be made using the camera-to-camera baseline.

Note that the least-squares matching process can be followed by a subsequent comparison process that compares ambiguous or doubtful x values with neighboring valid values that have been determined by the least-squares matching process. If the doubtful values are very close to neighboring valid values, they can be accepted, and otherwise rejected. When the least-squares technique is applied to find the pattern element (symbol) corresponding to the smallest sum of squares of differences, it is usually more efficient to do this with the data from the near view rather than data from the far view, as the number of near-view possibilities to be tried is normally smaller.

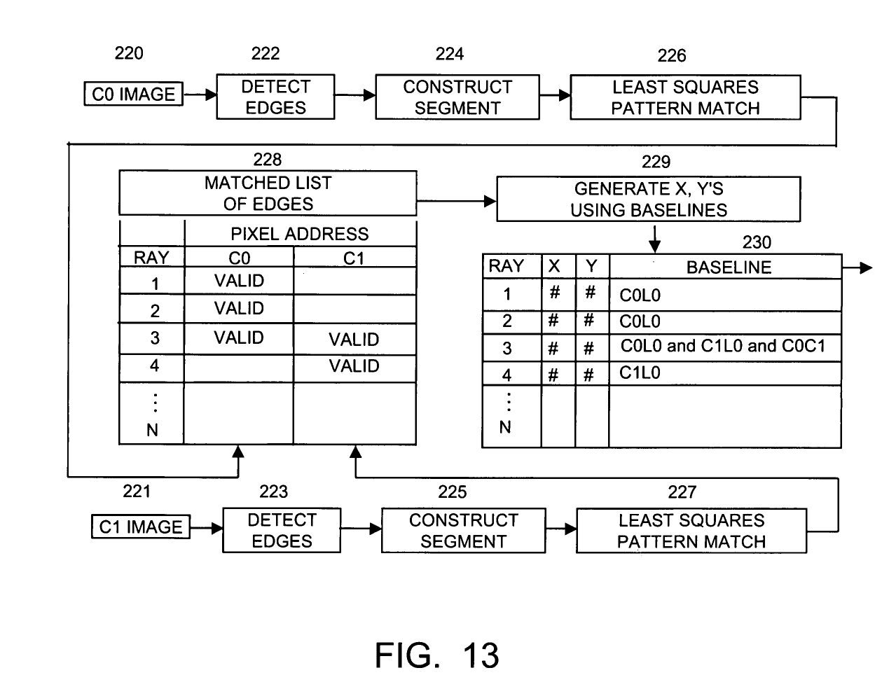

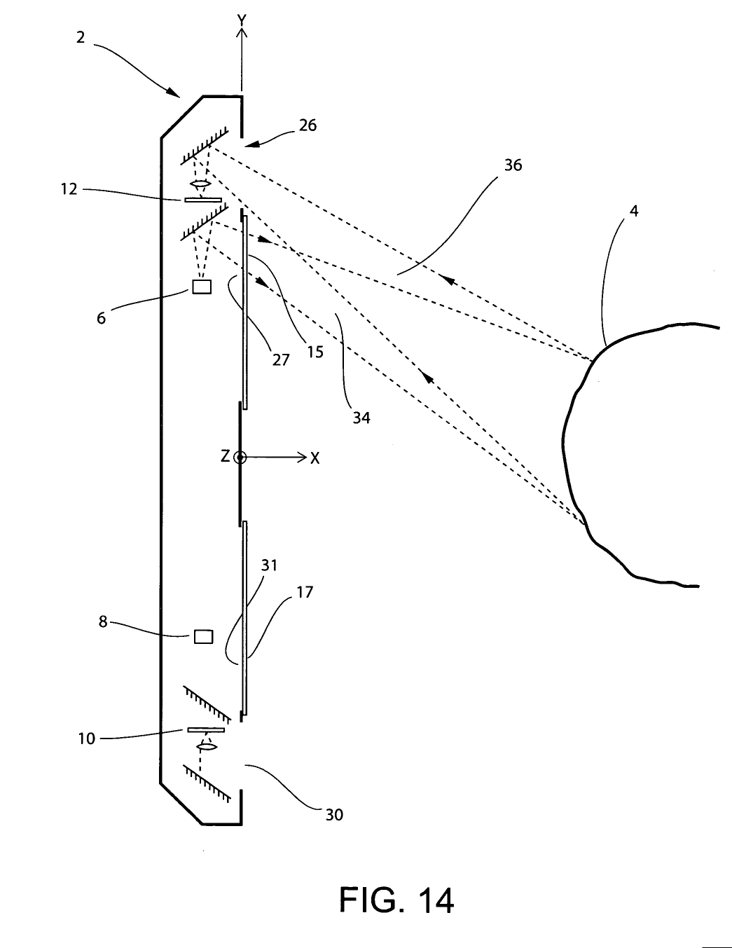

FIG. 13 shows a flow chart representing the manner in which the received reflection data signal is processed according to a preferred method of implementing the invention. Each detector camera signal 220, 221 is first put through the processes described above, viz

the edges of light and dark transitions are detected and identified (222, 223), culminating in the symbol boundary detection as at FIG. 11;

a raw segment is reconstructed (224, 225) as in the top graph in FIG. 12 at 102;

the raw segment is then compared (226, 227) with all possible de Bruijn segments projected and through a the process of least squares;

the best match with a projected segment is identified, as in FIG. 12 at the lower graph.

A further comparison 228 is then made between the two arrays of received pixel addresses for the identified patterns. The purpose of the comparison is to identify any reflected signals that are outside of the range of valid data for the projected beam sector but within the camera view sector. This might occur due to a beam distortion or reflection caused by an anomalous surface protrusion on the scanned object.

Having confirmed the validity of the identified reflected rays with their respective camera pixel addresses, it is then possible to carry out the triangulation computation of the (X,Y) coordinates of the portions of the object illuminated by the marks in the pattern. The angle of incidence of the projected marks is known as a function of the mask. The baseline distance from the point of projection to each corresponding pixel address in a camera detector is known once the scan head is calibrated. A perpendicular distance from the baseline to the point being scanned can thus be calculated. Through a simple distance subtraction of the distance from this baseline to the origin, located on the surface of the scan head, the distance from the mark to the surface is known. Another brief calculation using basic trigonometry can establish the horizontal distance from the scan head surface to the object—the corresponding x-value. For a given x-coordinate value, the y-coordinate value for a projected symbol is determined by the position of the mark on the mask, once the scan head has been calibrated. FIG. 1, as discussed previously, illustrates a ray-trace of the baselines and angles which corresponds to the trigonometry of the triangulation. In the preferred embodiment of the present invention, calculations from multiple baselines could be made to identify a particular x-value more accurately. Multiple baselines may be used if more than one camera and/or more than one laser are used. Such embodiments are described next.

In FIG. 13, suitable baselines are identified (229) and then the triangulation calculations performed (230), using valid baselines to identify the coordinates, in the X—Y plane, of the point from which the received ray was reflected. The output is then processed as determined by downstream signal processing chosen by the systems integrator or end user. Note that if for a given ray, valid data are obtained for both cameras (exemplified by ray 3 in box 228), then for that ray, the distance triangulation computation may be based on a camera-to-camera baseline. This is indicated by the C0C1 baseline possibility for ray 3 in box 229, although the other two baseline possibilities could be used instead, albeit at lower resolution of the distance value.

Referring again to FIG. 2, as each scan head 2 has two projectors 6, 8 and two cameras 10, 12; four modes of operation of the camera head are possible, and some of these may be implemented in one of two possible ways. These different modes of use provide versatility and reliability in the profiling of work pieces on a production line. These modes include the near-view mode (one camera, one neighboring projector nearby), the far-view mode (one camera, one projector remote from the camera), the single-beam dual-camera mode (a combination of the first two modes mentioned), and the dual-beam dual-camera mode (two cameras and two projectors, with alternating pattern projection from the two projectors). In other words, the data to be selected for processing may comprise the data from any of the combinations (1) first projector, neighboring camera; (2) second projector, neighboring camera; (3) first projector, remote camera; (4) second projector, remote camera.

(a) Far-View Mode

One of two possible implementations of this mode is illustrated in FIG. 2. The operating camera 10 is remote from the operating projector 6. The alternative implementation of the far-view mode would involve the operation of projector 8 and camera 12. This mode of operation is essentially that described in the prior Hermary patents. In the far-view mode, because of the relatively long baseline distance between a virtual projector focal point and the camera remote therefrom, triangulation will give a higher resolution of the distance from the baseline to a scanned point on the log 4, but pattern recognition tends to be less reliable than for near-view mode, described below.

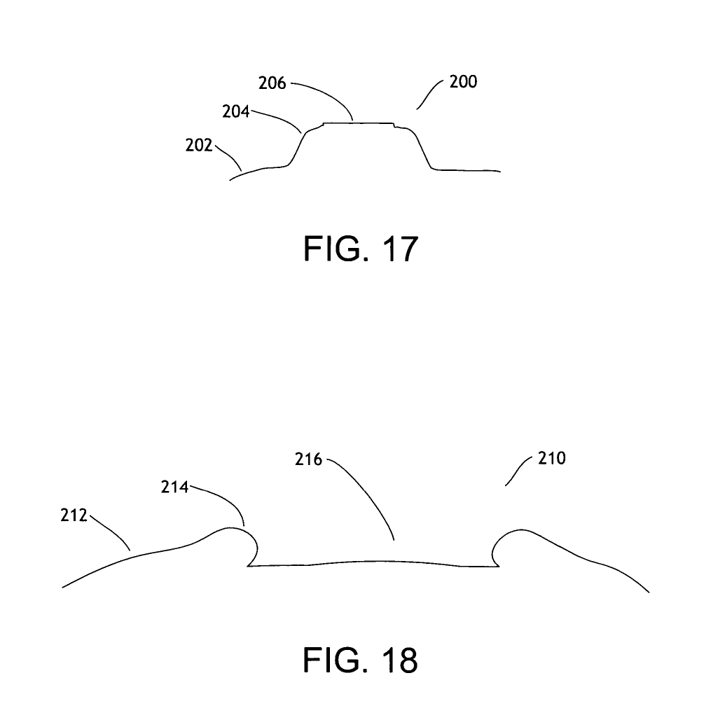

Because of the discrepancy between the angle of projection of any portion of the projected beam 34 and that of any portion of the image view 38 for the camera 10's viewing of the reflected light, there is a higher risk than for the near-view mode that cracks, gouges or protrusions (such as branch stems) may interfere with pattern recognition in the signal reflected back to the camera 10. Branch stems (FIG. 17) cast shadows on and occlude portions of the reflected image. Cat-face scars (FIG. 18) and cracks may absorb a portion of the light incident on the log 4. Both situations can cause the loss of pattern elements in the signal detected by the camera 10.

(b) Near-View Mode

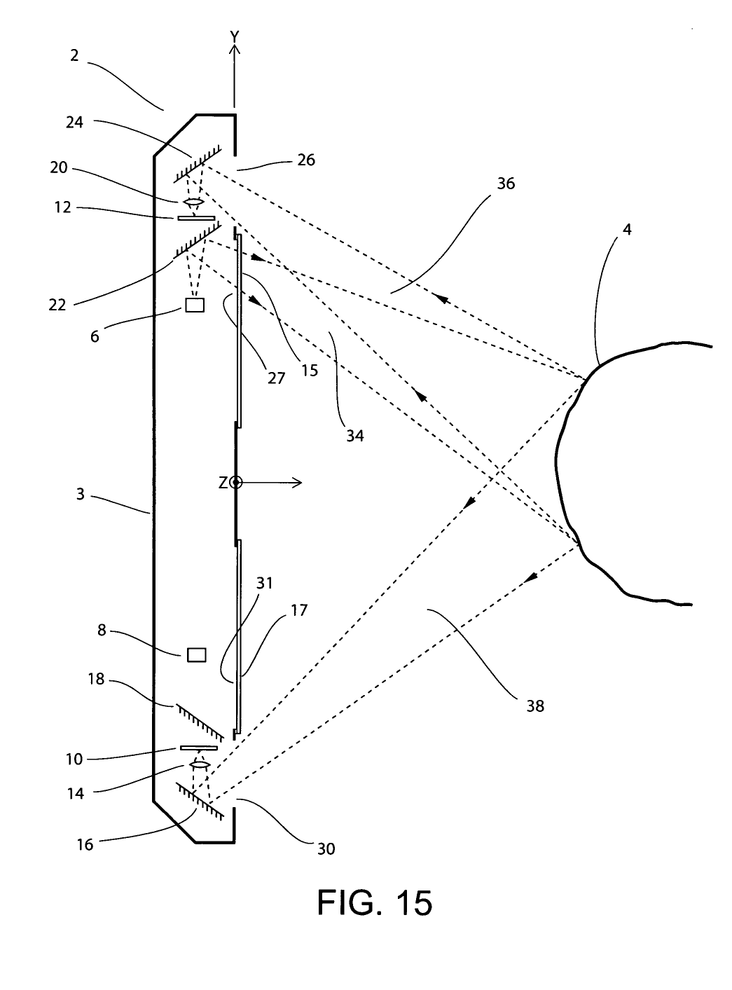

FIG. 14 shows scan head 2 operating with one projector 6 and its neighboring camera 12 that are separated by a distance sufficiently small that the angles of projection of the pattern elements and angles of reception of the reflected pattern elements are relatively close together, as compared to the previous far-view mode. Where the point on the object being scanned is relatively proximate to both the projector 6 and the camera 12, there is a high probability that the portion of the coded pattern applied to the scanned object in the vicinity of that scanned point will be accurately reflected back to the camera 12, thereby making it possible to recognize (resolve) the reflected coded pattern with a high probability of success. Surface defects tend not to interfere with reflected pattern resolution. In the case of a log, branch stems and cracks or gouges have a less deleterious effect on resolution of data in the detected light signal. However, distance measurement is less accurate than for far-view mode because of the short distance along the baseline between the projector 6 and the camera 12. Nevertheless, for maximum assurance that reflected symbols will be detected and properly recognized, it is desirable to keep the spacing between each projector and its neighboring near-camera to a minimum.

(c) Single-Beam Dual-Camera Mode

FIG. 15 illustrates one of two possible implementations of this mode. One projector 6 is shown as functioning to project beam 34 suitably coded by the mask 15, and both cameras 10, 12 detect the reflected signal from the log 4 that has been illuminated by the projector 6, through image views 36, 38 respectively. One camera, here camera 12, operates in near-view mode, while the other camera, here camera 10, operates in far-view mode. The alternative single-beam dual-camera implementation would substitute the projector 8 for the projector 6. This mode can be considered in its own right or as one-half of the complete cycle of the dual-beam dual-camera mode. Only one projector is considered to be in active operation in this mode.

The FIG. 15 mode of operation generates two useful reflected signals, the near-view signal enabling resolution of the reflected pattern with a high probability of success, and the far-view signal enabling computation of distance from the baseline to a scanned point with a relatively high resolution. The availability of both sets of reflected signal data for processing enables computations to be made, and constraints to be placed on the range of valid data, that would be impossible or appreciably less reliable if only the far-view mode were used.

In this single-beam dual-camera mode, the projected beam may be coded (typical if this mode is not merely half of a dual-beam dual-camera mode) or may be uncoded (typical of board scanning, for example, during one-half of a complete dual-beam dual-camera cycle). If the latter, it is possible that grain and defect detection (for example, defects such as knots in a cant) can be enhanced by generating pairs of gray-scale images that are captured simultaneously by the two cameras. It is possible in this way to collect further information about the surface being scanned, apart from its three-dimensional profile. Using uncoded projected light, observed variations in gray scale intensity in the image reflected from the X-Z planar surface of the object could be used to identify variations in grain and the presence of defects, such as knots. Reflectivity for given points could be compared to reflectivity for neigboring points; in a cant-scanning context, the consistency of reflectivity of the bulk of “neighbor” points scanned would be presumed to correlate with wood of reasonable quality. Reflectivity changes detected from scan to scan would indicate localized departures from values typical of higher quality wood, and could, for example, warn the operator that a knot or similar defect begins in the vicinity of the localized change in reflectivity. The position of each point in the gray-scale image could be determined through triangulation, preferably as a result of a coded light scan. It is further possible to compare the X Z planar data obtained from the gray scale scan to the X—Y planar data obtained from the triangulation scan to identify, with good precision, the edges of the object being scanned and the character of certain types of surface feature. Only one projector need be used for the gray scale scan. The reflected image from the other projector may help to identify protrusions that might result in anomalous data from the gray-scale scan. Thus using pairs of images, one could obtain reflectivity data on either side of a serious discontinuity on the surface of the scanned object. Such information could help to identify the type of discontinuity that caused the anomaly (e.g. a cat face scar or knot).

(d) Dual-Beam Dual-Camera Mode (Multiplexed Dual-Beam Binocular Mode)

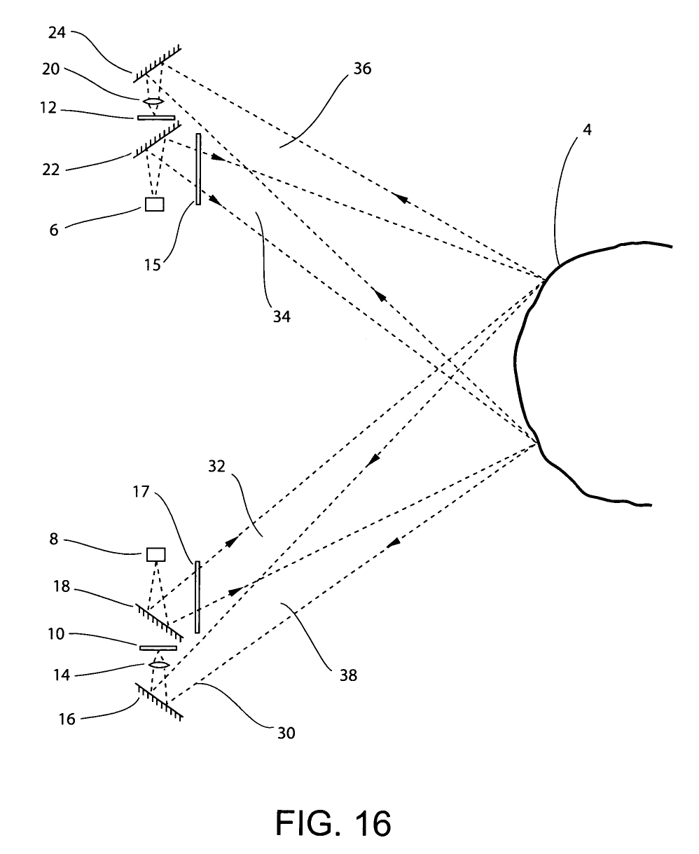

FIG. 16 shows schematically the preferred operation of a scan head 2 (for convenience illustrated without its housing) operating in a mode that multiplexes the beams from both projectors 6, 8 alternately operated. The two projected beams 32, 34 do not occur together at the same time; rather, they alternate in time-multiplexed sequence. So the two cameras 10, 12 view the reflected signal first from one projected beam 32 and then from the other projected beam 34; a scanning cycle comprises the projection and detection of both beams 32, 34 in sequence. By making use of two cameras 10, 12 having different views of the object (here, exemplary log 4) to be profiled, with a given camera functioning once in near-camera mode and once in far-camera mode in each scanning cycle, it is possible to derive four discrete reflected signal data sets, thereby improving the chances of obtaining accurate resolution of the reflected coded signal and relatively high distance computation for each scanned point, as compared with the apparatus described in the prior Hermary patents.

Surface imperfections on logs, such as branch stems, bark, cracks, gouges or cat-face scars may cause interruptions in detecting contiguous pattern elements (symbols) in the received data. FIG. 17 shows a profile of a typical severed branch stem 200. The general curvature of the neighboring portion of the log is shown as 202. A branch stem 200 has a characteristic shoulder 204 and a generally flat region 206 where the branch has been cut. FIG. 18 shows a profile of a typical cat-face scar 210 resulting from natural damage to the outer cambium of a tree. As the outer layers of a tree grow back, they form a characteristic cat-face profile. This profile has curved cheeks 214 bordering on flat region 216 of dead material.

It is evident that projected pattern symbols, particularly those projected at a sharp angle, may be occluded by irregularities of the foregoing type. Equally, the camera view of a portion of the reflected image may be occluded. The following types of problem may arise:

Projected light may be blocked from reaching the surface;

Reflected light may be deflected far from the detector or occluded entirely by a prominent feature such as a branch stem or the cheek of a cat-face scar;

Projected light may be attenuated or absorbed by surface features such as the cat-face scar through a ducting process called “the tracheid effect;”

Cracks or gouges may otherwise inadequately reflect the incident light.

Typically, such scanned object surface defects result in either the loss of pattern elements (symbols) or the incorrect sequencing of pattern elements in the full projected sequence. It is, of course, of commercial value to be able to identify the location of branch stems and cat-faces on logs, as these point out where knots and defective material are located. Knowing the location of such features makes it possible to saw logs selectively to avoid including such defects in finished lumber.

The described preferred log scanning embodiment of the invention, operating in the near-view mode, is able to provide reliable pattern symbol detection most of the time, notwithstanding prominent features such as branch stems, because the angles of incidence and reflection are close to one another. (In many cases, diffuse reflection occurs, but the camera viewing angle in near-view mode is necessarily close to the projection angle, for proximate surface points on the scanned object.) Since there are two spaced cameras, one camera can, for example, view the scar surface under one cheek of a cat-face scare, and the other camera can view the scar surface under the other cheek.

Note that if a log is badly scarred or is covered with residual bark debris or is otherwise rough, it may be desirable to scan the log with both a coarse and a fine pattern (i.e., one of relatively large pitch and the other of smaller pitch), one for each of the two multiplexed projectors, so that at least the coarse pattern will produce useful surface profile data, albeit at a lower resolution. The coarse pattern might also be used to establish boundaries in which sequences of finer patterns could be projected; the reflected data to be processed further could be confined to data within these boundaries to establish a degree of reliability.

In surface profile scanners such as those of the present invention that make use of beams carrying information in the form of patterns in the light, a large part of the data processing time is taken up in determining the match between the received pattern elements and the projected pattern. A considerable advantage of the preferred multiplexed dual-beam dual-camera embodiment of this invention is its ability to reduce data processing time by placing constraints on valid data as described below.

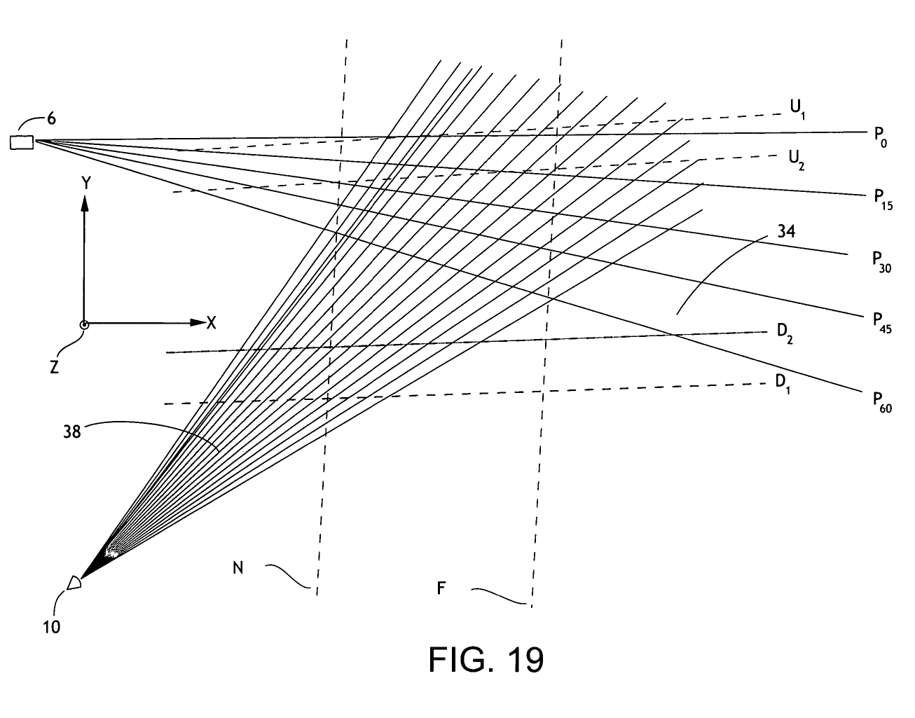

Constraints on valid data arise in part from the inherent design of the operating layout for the scanner according to the invention. Referring to FIG. 19, assuming that a sequence of 160 symbols is projected, the angular span of the beam 34 required to project pattern elements P1 to P60 is known, and the viewing angle required by the camera 10 within image view 38 is also known. The intersection of these two sectors is deliberately chosen to occur in the region in space in which the surface of the log 4 or other scanned object is expected to be present. Consequently, it is known a priori that if an initial reading of a point on the scanned surface has a y-coordinate that is above upper limit U1 (represented by a broken line in FIG. 19), such y-coordinate reading is necessarily invalid, since the projected beam has not been in any portion of the space above upper limit U1 that is within the view of the camera 10. Equally, if an initial reading of a point on the scanned surface has an ostensible y-coordinate that is below lower limit D1, that coordinate reading is necessarily invalid for a similar reason. Accordingly, reflection data that initially registers scanned points as having y-coordinates above upper limit U1 or below lower limit D1 can may be summarily rejected and need not be processed at all. Alternatively such data need not be rejected and may be used to alert the end user or system integrator that some anomaly exists in terms of the surface of the log—such as a large piece of hanging bark. An upper data rejection limit somewhat lower than limit U1, say U2, could be selected on the basis that there is a very high probability that no useful reflection data will place an apparent scanned point above limit U2. Similar reasoning permits selection of a somewhat higher value of lower limit D2.

Using similar analysis, limit line N can serve as a high-probability near limit for the x-coordinate of a scanned profile point, and limit line F can serve as a high-probability far limit for the x-coordinate of a scanned profile point. Data processing of data to which the FIG. 19 analysis applies can make use of the table labelled as “Matched List of Edges” in box 228 of FIG. 13.

The foregoing discussion is somewhat unsatisfactory in that data limits U1, U2, D1, D2 are shown in Cartesian coordinates, whereas it is for some purposes more useful to analyze the geometry of the projected beam and the field of view of a given camera by examining the ray pattern, and where convenient, using polar coordinates. From this perspective, one can predict that a portion of the scanned object proximate to camera 10 in FIG. 19 will necessarily be illuminated by a suitably coded beam delimited by, say, rays P30 and P60, and that that portion of the scanned object must necessarily be viewed within a corresponding subdivision of the angular field of view of the camera 10. This understanding makes it possible, according to one aspect of the present invention, to reject as invalid data (for that end of the scanned object) any portion of the projected pattern lying between projection rays P0 and P30, and to confine the analysis of the reflection data for that portion of the scanned object to a similarly restricted subdivision of the complete camera viewing range 38. [Note that the term “reject” does not necessarily imply an active data rejection step taken by the data processor. The term may signify, in appropriate contexts, the non-acceptance of unreliable data for further processing.]

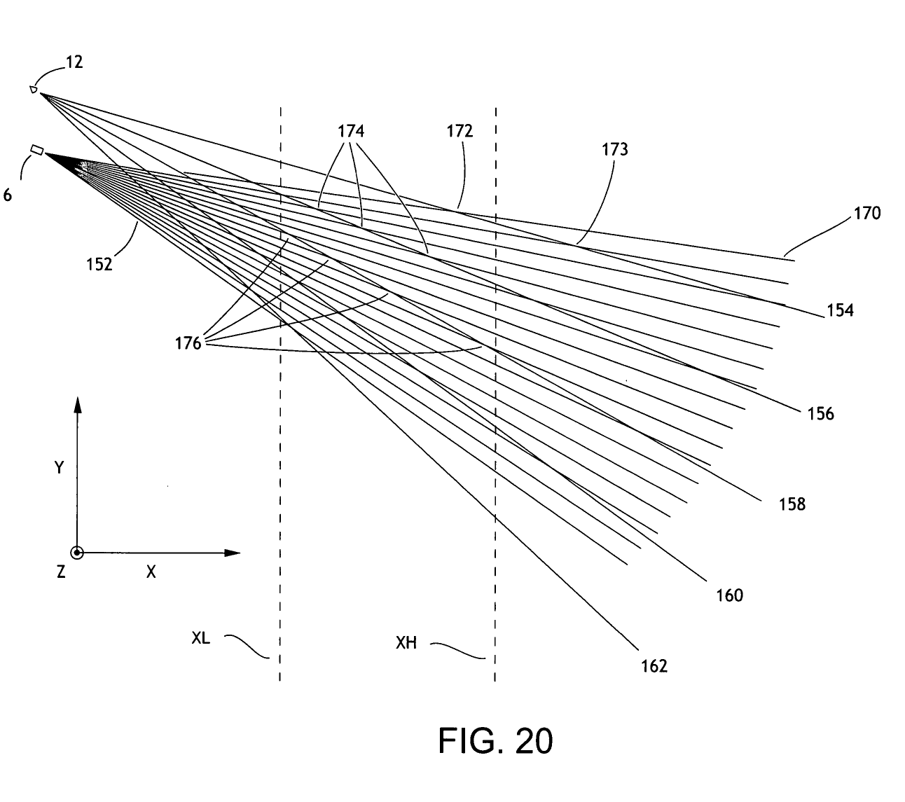

FIG. 20 shows a simplified schematic representation of near-view operation of the scan head 2. In FIG. 20, light from the projector 6 is projected as a fan-shaped beam 152 onto the target object (not shown in this illustration). Light reflected from the scanned object is received by a neighboring detector (camera) 12 near the projector 6. A suitable coded pattern is imposed on the projected beam 152 by a coding mask (not shown in FIG. 20). In this example, the projected beam is presumed to be coded with 17 pattern elements located at equally spaced angles across the beam 152. The projector line 170, at the upper limit of the projected beam 152, coincides with the first line in the series of pattern elements (symbols).

If an object is placed in the beam 152, the roughness of the surface of the scanned object will typically cause the light striking the object to be scattered in many directions. In particular, some light is reflected back towards the detector 12. The reception lines 154, 156, 158, 160 and 162 represent a selection of angles at which light might be received by the detector 12. If a portion of the surface of an object is located at the intersection of one of the reception lines and one of the projector lines, then this signifies that a pattern element has illuminated the object at that point and that some of the incident light has been reflected back to the detector 12.

As a matter of design, the location of the surface of the scanned object in the X-direction is constrained by the geometry of the apparatus, as discussed previously with reference to FIG. 19. In FIG. 20, the broken lines XL and XH exemplify (within the limits of Cartesian analysis) expected limits between which the scanned object's surface can reasonably be expected to be found. The limit line XH may be chosen to represent at least approximately the expected center-line through the scanned object. The line XL is displaced from line XH by a distance representing the maximum radius of log or other target object that can be profiled, a parameter set by the apparatus designer. Using lines XL and XH as boundary conditions, valid x-coordinate data are expected to be found in the range XL to XH.

Note that the limits XL, XH need not necessarily coincide with the limits N, F respectively of FIG. 19. The reason is that FIG. 19 illustrates the far-view mode of operation, whereas FIG. 20 illustrates the near-view mode of operation. The expected x-coordinate value range will not necessarily coincide for the two modes.

Referring to FIG. 20, if an observer were to sight along the ray 154 and detect a pattern element (symbol) corresponding to the first projected pattern element 170, it would be reasonable to infer that the received light had originated at the point 172 and not at another point located nearer than that or further away. A sighting along reception line 154 that revealed an apparent second symbol in the sequence at 173 would be rejected (or not accepted for further processing) as out of bounds, beyond far limit line XH. Since the line of projection 170 is at the upper extremity of the beam sector, it is impossible to have a point located nearer to the camera 12 than point 172. If the observer were to sight along the line 156, the light arriving at the detector could have been reflected from an object at any of the three points 174 coinciding respectively with the 3rd, 4th and 5th symbols in the sub-sequence under scrutiny. This ambiguity would have to be resolved by testing the received signal to determine the symbol to which the sighting corresponds, which would typically require not merely an analysis of that ambiguous sighting but also sightings preceding and following the ambiguous sighting. Similarly, a symbol received along the detector line 158 might be one of four projected symbols located at any of the four points 176, again requiring that the ambiguity be resolved.

The resolution of an ambiguity can often be accomplished using data for the same scanned point obtained from the other of the two cameras during its half-cycle of the multiplexed scanning of the point. If, for example, the output data from the near-view identifies a scanned point as corresponding to one of symbols 7, 8 or 9 in a symbol sequence, and the output data from the far-view identifies the same scanned point as corresponding to one of symbols 9 or 10 in the symbol sequence, it follows that the symbol must be the 9th in the sequence. To be doubly sure, one would test the data for points on either side of the ambiguous scanned point in order to be confident of the result. Note that often, the comparative analysis requires analysis of only a few symbols of the entire sequence of symbols projected; the foregoing implies that lower-level de Bruijn coding (or equivalent) can be selected than was required for the analytical approach taken in the prior Hermary patents.

Of course, the analysis and testing of data are done automatically by a suitable microprocessor or programmed computer. The algorithms used are as selected by the system designer and may be expected to vary considerably from one industrial plant to another. The design and selection of suitable analytical procedures, algorithms, data processing hardware and software generally, and data routing hardware and software, are not per se part of the present invention, but are left to the designer of the industrial process in which the present invention is to be employed.

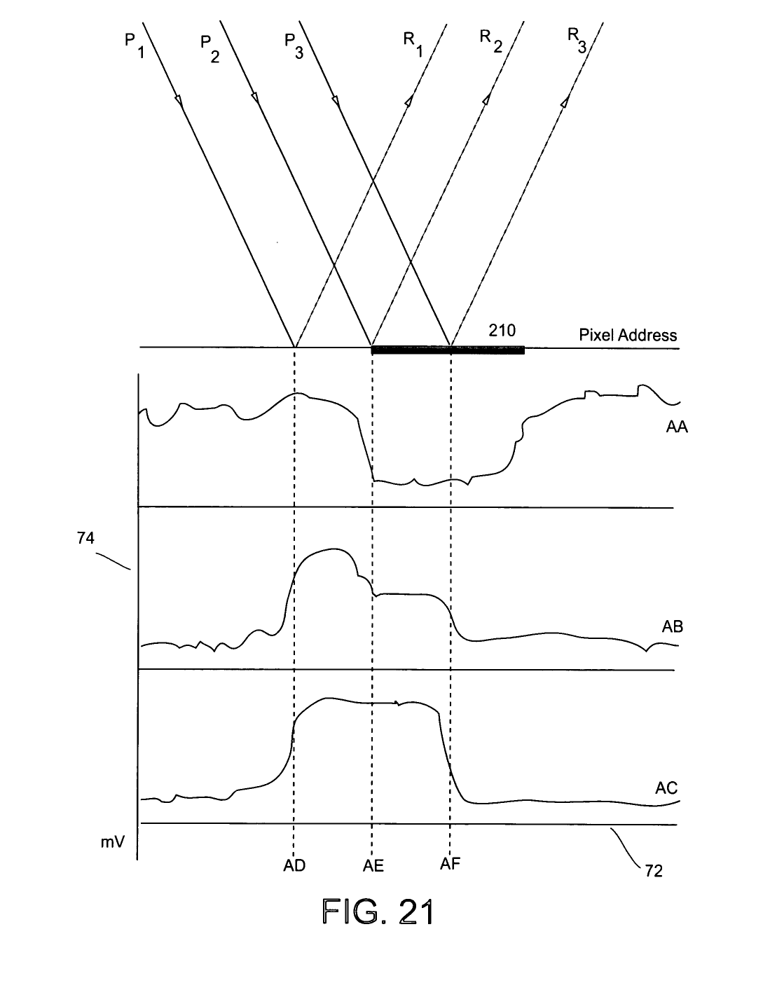

FIG. 21 is composite diagram comprising a ray trace diagram and complementary set of graphs showing how a scan head camera according to the invention that both detects coded light, for example projected de Bruijn symbols or other suitable mark/space symbols, and measures the relative reflectivities of symbol marks, may be used to correlate these two sets of data and thereby allow the deduction of additional information about the surface of the scanned object. The uppermost portion of the diagram is a ray trace diagram taken locally in the immediate vicinity of a target object over a short length of scan corresponding to a small range of camera pixel addresses. The three graphs underneath illustrate certain other data for the same pixel addresses as in the ray trace diagram (taken, for example, along horizontal scale 72) and maintain alignment with one another and with the ray trace diagram. The three graphs underneath are, from top to bottom, detected light intensity, reflectivity and compensated image diagrams. The values in the vertical scale 74 may be measured, for example, in millivolts.

A given detector is used to view the pattern for symbol recognition and also to measure the intensities of the light associated with the marks in the symbols. By way of example in FIG. 21, a knot or other surface defect 210 is present on the surface of the scanned object, the object being schematically represented in the drawing as a horizontal line of which surface defect 210 is a line segment. A mark of the de Bruijn pattern is projected onto the target surface between projection rays P1 to P3. The corresponding reflected rays that will be seen by the scan head camera are R1 to R3. Rays in the range R1 and R2 are from a portion of the target surface lacking imperfections are of relatively high intensity, but those reflected rays in the range R2 to R3 emanating from the knot 210 have been attenuated by the lower reflectivity of the knot 210.

As a consequence of the foregoing, the edges of the “darker” part of the mark as detected by the camera will be less distinct than the edges in the higher-reflectivity image, with the further consequence that the data processor may perceive incorrectly the foregoing effect as a pixel shift. This phenomenon can be referred to as pattern duty-cycle distortion, since it tends to generate false output data as to the length of the duty cycle of the mark. This error may be corrected through a comparison of the data received by the same camera in a gray-scale scan. In the gray scale, the presence of some surface defect such as the knot 210, its pixel address and coordinates in the X-Z plane will be known. Graph AA represents the detected intensity of the reflected light in the gray-scale scan. Note that the area between pixel addresses AD to AE shows the relatively high reflectivity of the object's surface. The area between pixel addresses AE to AF shows a relatively low reflectivity, corresponding to the attenuation caused by the surface anomaly 210. In graph AB, the reflectivity of the mark over the same pixel locations is shown. While the surface anomaly 210 is being illuminated, the lower reflectivity could be misinterpreted as either the end of the mark or alternatively an early falling edge of the mark; in either case the effect would be misidentified as a pixel shift. To overcome the effect of symbol duty-cycle distortion, one may compare the grey-scale and coded image reflectivities through a suitable selected data comparison process, including averaging or simple summation, yielding compensated image data. The compensated image data are shown at graph AC. By this methodology, duty-cycle distortion is reduced and the x, y coordinates of the scanned surface may be more accurately ascertained.

The invention can be implemented in a number of alternative embodiments that will occur to those skilled in the technology. The following are examples of variants:

(1) The source of the projected patterns need not be a laser producing a single frequency of light. Alternative sources of radiation in combination with suitable detectors sensitive to such radiation could be used. For example, the projectors and detectors can be selected to operate with frequencies higher or lower than in the visible spectrum that are better able to penetrate materials opaque to visible light.

(2) The two bands in a pattern element could be made of light of discernibly different frequencies. The projector in that case could superimpose light of the two frequencies to produce such a structured beam, or light of the two frequencies could be time-division multiplexed. Each camera would in such instance employ two separate detectors, each of which is able to detect and measure the intensity of light of a unique one of the two frequencies.

(3) The attribute whose change in value differentiates the two bands could be the polarization of the light. The projector in such an arrangement would produce two beams of light out of phase, preferably by 90°, that are suitably patterned and superimposed. The light received is split by its polarization and the intensity measured on two detectors, one for each polarization, whose outputs are combined.

(4) Three or more different types of symbols, instead of just two, could be employed. For example, the ratios of the widths of light bands to dark bands might have any of four values 1:4, 2:3, 3:2 and 4:1. Alternatively, the projected light could make use of three frequencies of light, such as red, green and blue.

(5) Frequency coding of the CCD elements in the CCD array in a camera can be devised in a manner that would facilitate data correlation.

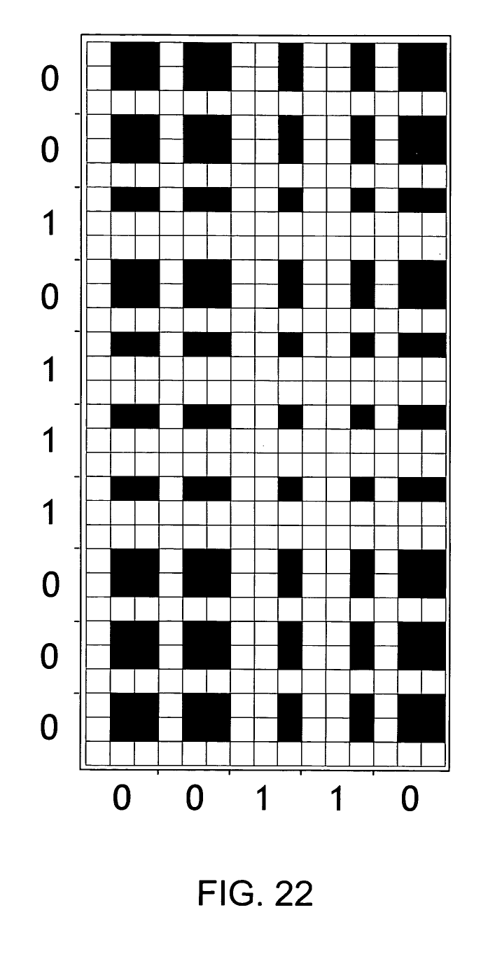

(6) The projected pattern could be a two-dimensional pattern instead of a one-dimensional pattern. By way of example, FIG. 22 shows a sample pattern generated with a (2,2) de Bruijn sequence in the X-direction and a (2,3) de Bruijn sequence in the Y-direction.

(7) In a further alternative embodiment involving two-dimensional coded patterns, at least one of the projectors is equipped with one or more lenses to broaden the projected beam so that a complete two-dimensional image is cast on the scanned object from one end to another, and possibly from one side to the other. Then, a two-dimensional pattern is imposed on this beam to provide the information necessary to correlate a portion of the received beam with that projected. With suitable processing, a single projection and reflected image reading by the scanner is sufficient to enable a complete surface profile of the surface scanned to be computed.

(8) One problem encountered with sheet-of-light scanners is the difficulty of distinguishing, in the field of view of the two-dimensional detector, between multiple lines reflected from the object. The pattern coding and matching techniques described in the preferred embodiment of this invention could be used to improve such a scanner's ability to discriminate between multiple lines.

Further modifications and variants will occur to those skilled in the art of scanner design, particularly the design of scanners for scanning objects moving along an industrial production line, such as logs and boards.

What is claimed is:

1. A scan head for use in a scanner for projecting light onto an object to be scanned, and for detecting light reflected from the object; the scan head having precisely two spaced light projectors and two spaced light detectors; wherein the projectors, when operating, operate in time-division multiplexed mode, and the detectors, when operating, each operate in synchrony to receive light reflected from both projectors.

2. A scan head as defined in claim 1, wherein at least one of the projectors projects coded light.

3. An array of spaced coplanar scan heads for scanning respective portions of a target object, each said scan head having precisely two spaced light projectors and two spaced light detectors; wherein, in operation
a. the projectors within each said scan head operate in time-division multiplexed mode;
b. the detectors within each said scan head operate in synchrony to receive light reflected from both projectors within such scan head; and
c. the scan heads operate in a timed sequence selected to avoid interference between neighboring scan heads.

4. A scan head as defined in claim 3, wherein at least one of the projectors projects coded light.

5. A scan head for use in a scanner for projecting light onto an object to be scanned, and for detecting light reflected from the object; the scan head having precisely two spaced projectors and two spaced detectors, wherein the detectors bracket the projectors.

6. A scan head as defined in claim 5, wherein at least one of the projectors projects coded light.

7. A scan head for use in a scanner for projecting light onto an object to be scanned, and for detecting light reflected from the object, the scan head having two spaced detectors and at least one projector for projecting coded light onto the object, wherein the projector is located proximate to one of the detectors and remote from the other, so that in operation, separate scan data are obtained from each said detector, the data respectively representing a near field of view and a far field of view.

8. A scan head for use in a scanner for projecting light onto a target object to be scanned, and for detecting light reflected from the object, the scan head having two spaced projectors and two spaced detectors; wherein in operation, one of the projectors projects a coded light pattern onto the object and the detectors receive and detect light reflected from the object that is correlatable with at least a distinguishable part of the projected pattern, and the other of the projectors projects a fan of light onto the object.

9. A scan head as defined in claim 8, wherein in operation, at least one of the detectors detects an image of the fan of light reflected from the target object and generate reflection data for at least one of the following purposes:
a. target edge detection of edges of the target object;
b. detection of other abrupt interruptions of the surface of the target object;
c. gray-scale imaging of the scanned surface of the target object;
d. selected color imaging of the scanned surface of the target object;
e. reflectivity compensation for balancing fan-of-light reflection data and coded-light reflection data.

10. Scanning apparatus for projecting coded light onto an object to be scanned, and for detecting light reflected from the object, comprising
a. a scan head having two spaced detectors and at least one projector for projecting coded light onto the object, wherein the projector is located proximate to one of the detectors and remote from the other, so that in operation, separate reflection data are obtained from each said detector, the data respectively representing a near field of view and a far field of view; the detectors each providing an output representing the detected image at any time received by such detector; and wherein the coded light comprises a pattern comprised of symbols each characterized by two or more distinguishable characteristics of the projected radiation;
b. symbol edge detection means for detecting in the output from the detectors beginning and end edges of the said symbol characteristics; and
c. matching means for matching portions of the detected image with portions of the projected pattern using at least some of the detected symbol edges.

11. Scanning apparatus as defined in claim 10, wherein the scan head has two projectors at least one of which in operation projects coded light onto the object, each said projector being proximate to an associated unique one of the detectors and remote from the other.

12. Scanning apparatus as defined in claim 11, wherein the detectors bracket the projectors.

13. Scanning apparatus as defined in claim 12, wherein in operation, both projectors project coded light onto the object.

14. Scanning apparatus as defined in claim 12, wherein in operation, one of the projectors projects coded light onto the object, and the other of the projectors projects a fan of light onto the object.

15. Scanning apparatus as defined in claim 12, wherein the pattern is comprised of symbols characterized by alternating light and dark portions of the projected pattern, and wherein the symbol edge detection means detects in the output from each said detector the rise times and fall times of portions of the output signal corresponding to the signal edges of sequential light and dark portions of the detected pattern, and the matching means matches portions of the detected reflected image with portions of the projected pattern using at least some of the detected symbol edges.

16. Scanning apparatus as defined in claim 13 in which, in operation, one said projector projects a coded light pattern smaller in pitch than the pitch of the coded light pattern projected by the other said projector.

17. Scanning apparatus as defined in claim 13 wherein the coded light projection pattern for the coded light projected by each said projector comprises three or more types of symbols, each said symbol having two discernibly different characteristics, the characteristics being respectively associated with discernibly different duty cycles for the symbol types, thereby to afford a basis for discerning the symbol type of each symbol in the pattern.

18. Scanning apparatus as defined in claim 17 wherein the symbols are of equal length and each comprise a mark and a space, the duty cycle of the mark varying with the symbol type.

19. Scanning apparatus as defined in claim 18 wherein the symbols are of three different types respectively having mark duty cycles of about 30%, about 50%, and about 70%.

20. Scanning apparatus for projecting light onto an object to be scanned, and for detecting light reflected from the object, comprising:
a. a scan head having two spaced detectors and at least one projector for projecting a coded light pattern onto the object, the detectors in operation each providing an output representative of the received reflected image at any time; wherein the projector is located proximate to one of the detectors and remote from the other, and wherein in operation, separate reflection data are obtained from each said detector, the data respectively representing a near view and a far view;
b. pattern recognition means receiving the near-view data and correlating the received image data with the projected pattern to establish a match; and
c. far-view distance determination means receiving the far-view data for fine determination of the distance from a selected baseline of points on the scanned object illuminated by portions of the projected pattern that have been correlated with corresponding portions of the received image.

21. Scanning apparatus as defined in claim 20, additionally comprising
a. near-view distance determination means receiving the near-view data for approximation of the distance from the selected baseline of points on the scanned object illuminated by portions of the projected pattern that have been correlated with corresponding portions of the received image; and
b. matching means for matching far-view distance data with
i. pattern data from the pattern recognition means; and
ii. near-view distance data from the near-view distance determination means;
so as to select for further processing the far-view distance data that meets or approximately meets matching criteria selected for the matching of the far-view distance data with the pattern data and the near-view distance data.

22. Scanning apparatus as defined in claim 21, in combination with means for moving the object past the scanner in a path orthogonal to the line joining the detectors and orthogonal to the distance dimension.

23. Scanning apparatus as defined in claim 21, in combination with triangulation computation means for computing the distance from a baseline to a series of points on the scanned object and that employs as the baseline the line joining the two cameras when a given one of said points is known to have been recognized by both detectors.

24. A method of processing reflection data obtained from scanning an object with a coded light pattern, comprising selection of data within one or more ranges established by the scanning layout and/or the angles of projection and view selected; and further processing only the selected data.

25. A method of processing reflection data obtained at two separate locations from the projection from a source onto a scanned object of a coded light pattern, comprising correlating the reflection data received at the location nearer the source with the projected pattern so as to establish a correlation between components of the reflected image of the projected pattern and points on the scanned object, approximating the distance from the said points on the scanned object to a selected baseline; and more precisely determining the distance from the said points on the scanned object to the selected baseline by triangulation computations on selected correlated data received at the location further from the source, including selecting for reliable triangulation computation only data for which the more precise distance determination is within the same selected distance range as the corresponding approximate distance determination.

26. A method of processing reflection data obtained from at least two separate light-detection locations from the reflection of an image from a scanned object of a coded light pattern projected onto the scanned object from a source of light, comprising triangulation computation of distance to an identified point on the scanned object from at least two discrete baselines, one said baseline being of a length correlatable with the distance from the source to one of the two separate locations, and the other said baseline being of a length correlatable with the distance from the source to the other of the two separate locations.

27. A method of processing reflection data obtained from two separate light-detection locations from the reflection of an image from a scanned object of a coded light pattern projected onto the scanned object from a source of light, comprising establishing the identity of scanned points from which the reflection data have been obtained at the two separate light-detection locations, and performing triangulation computation of distance to such identified points on the scanned object using as a baseline the line between the applicable detection focal points at the two separate light-detection locations.

28. A method of processing first and second sets of reflection data correlated with a selected range of pixel addresses with which the reflection data are associated, the first set of said reflection having been obtained from the reflection of at least a portion of a series of mark/space symbols projected onto a target object and being representative of the intensity of light reflected at each pixel address in the range, the marks being characterized by two or more duty-cycle values for purposes of mark recognition and identification, and the second set of data having been obtained as reflectivity data representative of the surface reflectivity of the scanned surface of the target object at each pixel address in the range, comprising compensating the first set of data using the second set of data thereby to obtain compensated data for the range of pixel addresses that reduces or mitigates the duty-cycle distortion of mark-related data induced by surface anomalies on the target object surface.
